(19) United States
(12) Patent Application Publication
(10) Pub. No.: US 2013/0196205 A1
(43) Pub. Date: Aug. 1, 2013

(54) ENERGY STORAGE SYSTEM

(71) Applicant: EnerDel, Inc., Greenfield, IN (US)

(72) Inventors: Bruce Silk, Indianapolis, IN (US); Derrick Buck, Pendleton, IN (US)

(73) Assignee: ENERDEL, INC., Greenfield, IN (US)

(21) Appl. No.: 13/793,155

(22) Filed: Mar. 11, 2013

Related U.S. Application Data
(63) Continuation-in-part of application No. PCT/US2012/040776, filed on Jun. 4, 2012.
(60) Provisional application No. 61/493,275, filed on Jun. 3, 2011.
(60) Provisional application No. 61/543,781, filed on Oct. 5, 2011.

(51) Int. Cl. H01M 2/10; B23P 11/00

(52) U.S. Cl. CPC H01M 2/1016; B23P 11/00
USPC 429/99; 29/428

(57) ABSTRACT

Battery assemblies are disclosed which may include a plurality of battery cells removably coupled to a support. The support may include trays which are stacked. The battery cells of each tray may be electrically connected together. The battery trays may include a battery support which extends under and supports a middle portion of the battery cells of the respective battery tray. The battery support may be a thermal sink for the battery cells. The plurality of cells may be coupled to a support with a compression member including a plurality of heat transfer members.

### RELATED APPLICATIONS

This application is a continuation-in-part of PCT Application No. PCT/US2012/040776, filed Jun. 4, 2012, titled ENERGY STORAGE SYSTEM which claims the benefit of U.S. Provisional Patent Application Ser. No. 61/493,275, titled ENERGY STORAGE SYSTEM, filed Jun. 3, 2011 and U.S. Provisional Patent Application Ser. No. 61/543,781, titled ENERGY STORAGE SYSTEM, filed Oct. 5, 2011, the disclosures of which are expressly incorporated by reference herein.

The disclosure of PCT Application No. PCT/US11/52169, filed Sep. 19, 2011, titled ENERGY STORAGE SYSTEM, is expressly incorporated by reference herein.

### FIELD

The disclosure relates in general to methods and systems for storing and providing energy with a plurality of batteries and, more particularly, to methods and systems for storing and providing energy to a stationary energy storage market with a plurality of batteries.

### BACKGROUND

Energy storage systems are known. Exemplary energy storage systems are disclosed in PCT Application No. PCT/US11/52169, filed Sep. 19, 2011, titled ENERGY STORAGE SYSTEM, the disclosure of which is expressly incorporated by reference herein.

### SUMMARY

In an exemplary embodiment of the present disclosure, an energy storage system is provided having a plurality of stackable trays and electrical interconnections between the trays being made from an exterior of the plurality of stackable trays.

In another exemplary embodiment of the present disclosure, a battery assembly is provided. The battery assembly comprising a first tray including a first negative terminal; a first positive terminal; a first plurality of prismatic battery cells electrically connected together and arranged in a side-by-side configuration, the first plurality of prismatic cells being electrically connected to the first negative terminal and the first positive terminal; and a first battery support supporting the first plurality of prismatic battery cells, the first battery support extending under and supporting a middle portion of each of the first plurality of prismatic battery cells, supporting the first negative terminal, and supporting the first positive terminal. The battery assembly further comprising a second tray supported by the first tray, the second tray including a second negative terminal; a second positive terminal; a second plurality of prismatic battery cells electrically coupled together and arranged in a side-by-side configuration, the second plurality of prismatic cells being electrically connected to the second negative terminal and the second positive terminal; and a second battery support supporting the second plurality of prismatic battery cells, the second battery support extending under and supporting a middle portion of each of the second plurality of prismatic battery cells, supporting the second negative terminal, and supporting the second positive terminal. The battery assembly further comprising at least one electrical connector removably coupled to at least two of the first negative terminal, the first positive terminal, the second negative terminal, and the second positive terminal from an exterior of the battery assembly.

In an variation of the another exemplary embodiment, the first tray includes a first set of nesting features and the second tray includes a second set of nesting features, the first set of nesting features and the second set of nesting features cooperating to locate the second tray relative to the first tray.

In another variation of the another exemplary embodiment, the second tray is supported by the first tray in a manner that a solid stack is made from a top surface of the second battery support of the second tray through to a bottom surface of the first battery support of the first tray in regions of the first tray spaced apart from the first plurality of prismatic battery cells. In a refinement of the another variation, the solid stack is provided in a first region about a perimeter of the first tray and about a perimeter of the second tray and in a second region extending between a first group and a second group of the first plurality of prismatic battery cells of the first tray and extending between a third group and a fourth group of the second plurality of prismatic battery cells of the second tray. In a further refinement of the another variation, the first tray includes a plurality of handles, each handle including an aperture extending from a top side of the first tray through to a bottom side of the first tray, a portion of the first tray bounding each handle being part of the first region of the solid stack.

In still another variation of the another exemplary embodiment, the first tray includes a first plurality of handles, each handle of the first plurality of handles including an aperture extending from a top side of the first tray through to a bottom side of the first tray and the second tray includes a second plurality of handles, each handle of the second plurality of handles including an aperture extending from a top side of the second tray through to a bottom side of the second tray. In a refinement of the still another variation, the first plurality of handles includes a first handle positioned proximate a first corner of the first tray and the second plurality of handles includes a second handle positioned proximate a second corner of the second tray, the aperture of the second handle of the second tray aligning with the aperture of the first handle of the first tray when the second tray is supported by the first tray. In another refinement of the still another variation, the first plurality of handles define a first outer envelope of the first tray and the second plurality of handles define a second outer envelope of the second tray. In still another refinement of the still another variation, the first battery support is identical to the second battery support and the second outer envelope of the second tray matches the first outer envelope of the first tray.

In a further variation of the another exemplary embodiment, the first tray includes a plurality of voltage sensors, each providing an indication of a voltage associated with the first plurality of prismatic battery cells, and a plurality of temperature sensors, each providing an indication of a temperature associated with the first plurality of prismatic battery cells. In a refinement of the further variation, the first tray includes a first connector operatively coupled to the plurality of voltage sensors and to the plurality of temperature sensors. In a further refinement of the further variation, the first connector is accessible from a first side of the first battery support of the first tray, the first negative terminal and the first positive terminal also being accessible from the first side of the first battery support of the first tray. In still another refinement of the further variation, the first tray includes a first connector operatively coupled to one of the plurality of voltage sensors and the plurality of temperature sensors and a second connector operatively coupled to the other of the plurality of voltage sensors and the plurality of temperature sensors. In yet still another refinement of the further variation, the first connector is accessible from a first side of the first battery support of the first tray and the second connector is accessible from a second side of the first battery support, the first negative terminal and the first positive terminal being accessible from one of the first side of the first battery support and the second side of the first battery support. In a further refinement of the further variation, the battery assembly further comprises a battery management tray stacked with the first tray and the second tray, the battery management tray supporting a controller operatively coupled to the plurality of voltage sensors of the first tray and to the plurality of temperature sensors of the first tray. In yet still a further refinement of the further variation, the controller is operatively coupled to the plurality of voltage sensors and the plurality of temperature sensors through at least one wired connection. In yet still another refinement of the further variation, the plurality of voltage sensors of the first tray monitor a voltage between each of the first plurality of prismatic battery cells. In still yet a further refinement of the further variation, the plurality of temperature sensors of the first tray include a first temperature sensor positioned proximate to a terminal of a first battery cell of the first plurality of battery cells, the first temperature sensor being received in a pocket in the first battery support of the first tray. In still a further refinement of the further variation, the pocket in the first battery support of the first tray includes a plurality of standoffs which reduce a thermal connection between the first temperature sensor and the first battery support.

In still a further variation of the another exemplary embodiment, the first plurality of prismatic battery cells include a first cell having a first terminal extending from a first side of the first cell and a second cell having a second terminal extending from a second side of the second cell, the first terminal of the first cell and the second terminal of the second cell being positioned in an overlapping arrangement over a first portion of the first battery support and held in contact with each other with a compression member, the first portion of first battery support being crowned to assist in maintaining the first terminal of the first cell in electrical contact with the second terminal of the second cell. In a refinement of the still a further variation, the first battery support includes a plurality of overmolded studs positioned proximate the first portion, the compression member including a plurality of apertures to receive the plurality of overmolded studs, the compression member being secured to the plurality of overmolded studs through a plurality of fasteners. In another refinement of the still a further variation, the compression member includes a plurality of heat transfer fins along an upper side.

In still yet a further variation of the another exemplary embodiment, the first negative terminal, the first positive terminal, the second negative terminal, and the second positive terminal are accessible from a first side of the battery assembly.

In still yet another variation of the another exemplary embodiment, one of the first negative terminal and the first positive terminal and one of the second negative terminal and the second positive terminal are positioned proximate each other and are electrically coupled together with a first removable electrical connector. In a refinement of the still yet another variation, the battery assembly further comprises a cover removably coupled to the first tray and the second tray to cover the first removable electrical connector. In another refinement of the still yet another variation, the first tray and the second tray include blocking members which separate one of the first negative terminal and the first positive terminal from the terminal of the second tray having the opposite polarity.

In yet still another variation of the another exemplary embodiment, one of the first negative terminal and the first positive terminal and one of the second negative terminal and the second positive terminal are positioned proximate each other and are electrically coupled together with a first removable electrical connector and wherein the other of the first negative terminal and the first positive terminal and the other of the second negative terminal and the second positive terminal are positioned proximate each other and are electrically coupled together with a second removable electrical connector. In a refinement of the yet still another variation, the first removable electrical connector and the second removable electrical connector are keyed to be non-interchangeable. In another refinement of the yet still another variation, the first tray and the second tray are keyed resulting in the first removable electrical connector and the second removable electrical connector being non-interchangeable.

In yet still a further variation of the another exemplary embodiment, the first plurality of prismatic battery cells and the second plurality of prismatic battery cells, each have a cell pouch, a positive terminal extending from a first side of the cell pouch, and a negative terminal extending from a second side of the cell pouch, the second side being opposite the first side, at least one terminal of each of the plurality of prismatic battery cells is in an overlapping relationship with the terminal of at least one adjacent prismatic battery cell.

In a further still variation of the another exemplary embodiment, the first plurality of prismatic battery cells and the second plurality of prismatic battery cells, each have a cell pouch, a positive terminal extending from a first side of the cell pouch, and a negative terminal extending from the first side of the cell pouch.

In a further exemplary embodiment of the present disclosure, a method of assembling a battery assembly is provided. The method comprising the steps of obtaining a plurality of trays, each tray including a negative terminal, a positive terminal, a plurality of prismatic battery cells electrically connected to the negative terminal and the positive terminal and a battery support supporting the plurality of prismatic battery cells in a side-by-side arrangement, the battery support extending under a middle portion of each of the plurality of prismatic battery cells; stacking the plurality of trays; and coupling at least one electrical connector to at least two of the negative terminals of the stacked plurality of trays and the positive terminals of the stacked plurality of trays, the at least one electrical connector being removeable from an exterior of the stacked plurality of trays.

In a variation of the further exemplary embodiment of the present disclosure when the at least one electrical connector is removed from the stacked plurality of trays to uncouple the at least two of the negative terminals of the stacked plurality of trays and the positive terminals of the stacked plurality of trays a voltage of the stacked plurality of trays is under 50 volts and when the at least one electrical connector is coupled to the at least two of the negative terminals of the stacked plurality of trays and the positive terminals of the stacked plurality of trays the voltage of the stacked plurality of trays is greater than 50 volts.

In yet a further exemplary embodiment of the present disclosure, a method of assembling a battery assembly is provided. The method comprising the steps of obtaining a plurality of trays, each tray including a negative terminal, a positive terminal, a plurality of prismatic battery cells electrically connected to the negative terminal and the positive terminal and a battery support supporting the plurality of prismatic battery cells in a side-by-side arrangement, the battery support extending under a middle portion of each of the plurality of prismatic battery cells; stacking the plurality of trays, the respective battery supports of each of the plurality of trays cooperating to form a solid stack from a top side of the stacked plurality of trays to a bottom side of the stacked plurality of trays, wherein the solid stack is provided in a first region about a perimeter of each tray of the stacked plurality tray and in a second region of each tray extending between a first group and a second group of the respective plurality of prismatic battery cells of the tray; and coupling at least one electrical connector to at least two of the negative terminals of the stacked plurality of trays and the positive terminals of the stacked plurality of trays to electrically couple the plurality of prismatic cells of the trays together.

In a variation of the yet a further exemplary embodiment, the at least one electrical connector is removably coupled from an exterior of the stacked plurality of trays. In a refinement of the variation the terminals of the plurality of trays are accessible from a first side of the stacked plurality of trays and a second side is a base for the plurality of stacked trays.

In another variation of the yet a further exemplary embodiment, the plurality of trays each includes a plurality of handles, each handle including an aperture extending from a top side of the tray through to a bottom side of the tray, a portion of the tray bounding each handle being part of at least one of the solid stack. In a refinement of the another variation, the step of stacking the plurality of trays includes the step of aligning the apertures of the respective handles of the respective trays. In another refinement of the another variation, the plurality of handles define an outer envelope of the stacked plurality of trays.

In still another variation of the yet a further exemplary embodiment, the step of stacking the plurality of trays includes the step of aligning nesting features of the respective trays to reduce relative translational movement of the respective trays.

In still yet a further exemplary embodiment of the present disclosure, a battery assembly is provided. The battery assembly comprising a plurality of prismatic battery cells electrically coupled together and arranged in a side-by-side configuration; and a battery support supporting the plurality of battery cells in the side-by-side configuration, the battery support extending under and supporting a middle portion of each of the plurality of prismatic battery cells, wherein the battery support maintains a generally constant temperature across the battery support during cycling of the plurality of prismatic battery cells.

In a variation of the still yet a further exemplary embodiment, the generally constant temperature across the battery support corresponds to up to a 4 degree temperature variation across the battery support. In a refinement of the variation, the generally constant temperature across the battery support is maintained while the plurality of prismatic battery cells are cycled at a 5 C rate.

In another variation of the still yet a further exemplary embodiment, the battery support is made of a sheet molded composite material that is an electrical insulating material. In a refinement of the another variation, the generally constant temperature across the battery support is maintained in an absence of a heat transfer fluid flowing relative to the plurality of prismatic battery cells.

In still another variation of the still yet a further exemplary embodiment, the generally constant temperature across the battery support is maintained while the plurality of prismatic battery cells are surrounded by a generally static volume of air.

In still another exemplary embodiment of the present disclosure, a battery assembly is provided. The battery assembly comprising a plurality of prismatic battery cells electrically connected together and arranged in a side-by-side configuration; and a battery support supporting the plurality of battery cells in the side-by-side configuration, the battery support extending under and supporting a middle portion of each of the first plurality of prismatic battery cells, wherein the plurality of prismatic battery cells include a first cell having a first terminal extending from a first side of the first cell and a second cell having a second terminal extending from a second side of the second cell, the first terminal of the first cell and the second terminal of the second cell being positioned in an overlapping arrangement over a first portion of the battery support and held in contact with each other with a compression member, the first portion of battery support being crowned to assist in maintaining the first terminal of the first cell in electrical contact with the second terminal of the second cell.

In a variation of the still another exemplary embodiment, the battery support includes a plurality of overmolded studs positioned proximate the first portion, the compression member including a plurality of apertures to receive the plurality of overmolded studs, the compression member being secured to the plurality of overmolded studs through a plurality of fasteners.

In another variation of the still another exemplary embodiment, the compression member includes a plurality of heat transfer fins along an upper side.

In still another variation of the still another exemplary embodiment, the battery support includes a wall which separates the first cell from the second cell except for at the first portion of the battery support whereat the first terminal of the first cell and the second terminal of the second cell being positioned in an overlapping arrangement.

In still a further yet exemplary embodiment of the present disclosure, a battery assembly is provided. The battery assembly comprising a plurality of prismatic battery cells electrically connected together and arranged in a side-by-side configuration; and a battery support supporting the plurality of battery cells in the side-by-side configuration, the battery support extending under and supporting a middle portion of each of the plurality of prismatic battery cells, wherein the battery support includes a plurality of handles which define an outer envelope of the battery support.

In a variation of the still a further yet exemplary embodiment, the plurality of prismatic battery cells include a first cell having a first terminal extending from a first side of the first cell and a second cell having a second terminal extending from a second side of the second cell, the first terminal of the first cell and the second terminal of the second cell being positioned in an overlapping arrangement over a first portion of the battery support and held in contact with each other.

In another variation of the still a further yet exemplary embodiment, each handle includes an aperture extending from a top side of the battery support through to a bottom side of the battery support.

In a further variation of the still a further yet exemplary embodiment, the plurality of handles includes a first handle positioned proximate a first corner of the battery support and a second handle positioned proximate a second corner of the battery support.

In still a further variation of the still a further yet exemplary embodiment, the battery assembly further comprises a positive terminal supported by the battery support and a negative terminal supported by the battery support, the positive terminal and the negative terminal being electrically coupled to the plurality of prismatic battery cells, the positive terminal and the negative terminal being positioned within the outer envelope defined by the plurality of handles.

In still yet another exemplary embodiment of the present disclosure, a battery assembly is provided. The battery assembly comprising a plurality of prismatic battery cells electrically connected together and arranged in a side-by-side configuration; and a battery support supporting the plurality of battery cells in the side-by-side configuration, the battery support extending under and supporting a middle portion of each of the plurality of prismatic battery cells, wherein the battery support has a height to length ratio of up to about 10 percent.

In a variation of the still yet another exemplary embodiment, the height to length ratio is up to about 5 percent.

In another variation of the still yet another exemplary embodiment, the height to length ratio is about 2 percent.

In a further variation of the still yet another exemplary embodiment, the height to length ratio is up to about 1.5 percent.

In yet a further variation of the still yet another exemplary embodiment, the height to length ratio is up to about 1 percent.

In still yet a further exemplary embodiment of the present disclosure, a battery assembly is provided. The battery assembly comprising a plurality of prismatic battery cells electrically connected together, each of the plurality of prismatic battery cells having a cell pouch, a positive terminal and a negative terminal both extending from a first side of the cell pouch; and a battery support supporting the plurality of prismatic battery cells, the battery support extending under and supporting a middle portion of each of the plurality of prismatic battery cells, wherein the plurality of prismatic battery cells include a first cell, a second cell, and a third cell, the positive terminal of the first cell and the negative terminal of the second cell being electrically connected together and positioned in an overlapping arrangement, a middle portion of the first cell and a middle portion of the second cell being positioned in a non-overlapping arrangement, the positive terminal of the second cell and the negative terminal of the third cell being electrically connected together and positioned in an overlapping arrangement, and the middle portion of the second cell and a middle portion of the third being positioned in a non-overlapping arrangement.

In a variation of the still yet a further exemplary embodiment, the terminals of the first cell, the second cell, and the third cell are oriented towards a center of the battery support

In a further embodiment of the present disclosure, a battery system is provided. The battery system comprising a plurality of prismatic battery cells including a first cell having a first terminal extending from the first cell and a second cell having a second terminal extending from the second cell; a support locating the plurality of prismatic cells such that the first terminal of the first cell overlaps the second terminal of the second cell; and a compression member removably coupled to the support, the compression member holding the first terminal of the first cell in contact with the second terminal of the second cell, the compression member including a plurality of heat sink features.

In an example of the further embodiment, the compression member includes a plurality of heat transfer fins along an upper side.

In another example of the further embodiment, the compression member includes a base portion which holds the first terminal of the first cell in contact with the second terminal of the second cell and the plurality of heat sink features include a plurality of fins extending from the base portion on a side opposite of the first cell and the second cell. In a variation of the another example, the plurality of fins define a conduit therebetween that receives a flow of air to cool the first and second cells. In another variation of the another example, the conduit has a longitudinal axis which is parallel to a top face of the first cell and a top face of the second cell. In a further variation of the another example, the conduit is further defined by the support.

In a further example of the further embodiment, the compression member includes a base portion which holds the first terminal of the first cell in contact with the second terminal of the second cell and the plurality of heat sink features include a plurality of fins extending from the base portion, the plurality of fins defining a conduit therebetween that receives air to cool the first and second cells, wherein the conduit has a longitudinal axis which is parallel to a top face of the first cell and a top face of the second cell. In another variation of the further example, the conduit is spaced apart from the first terminal of the first cell and the second terminal of the second cell.

In yet another example of the further embodiment, the support includes a plurality of overmolded studs positioned proximate the first cell and the second cell and wherein the compression member includes a plurality of apertures to receive the plurality of overmolded studs, the compression member being secured to the plurality of overmolded studs through a plurality of fasteners.

In still yet another example of the further embodiment, the support is a tray which supports the first cell and the second cell in a side-by-side arrangement, the battery support extending under a middle portion of each of the first cell and the second cell.

In still a further example of the further embodiment, the support surrounds a perimeter of the first cell. In a variation of the still further example, the support surrounds a perimeter of the second cell.

In a further still example of the further embodiment, the support surrounds the compression member.

In yet a further still example of the further embodiment, the plurality of prismatic cells are electrically coupled together and are electrically coupled to a positive terminal supported by the support and a negative terminal supported by the support. In a variation of the yet further still example, the positive terminal and the negative terminal are positioned along a first side of the support and the compression member is spaced apart from the first side of the support. In another variation of the yet further still example, the plurality of prismatic battery cells further includes a third cell having a third terminal extending from the third cell and a fourth cell having a fourth terminal extending from the fourth cell, the support locating the plurality of prismatic cells such that the third terminal of the third cell overlaps the fourth terminal of the fourth cell; and further including a second compression member removably coupled to the support, the second compression member holding the third terminal of the third cell in contact with the fourth terminal of the fourth cell, the second compression member including a second plurality of heat sink features. In a variation thereof, the plurality of heat transfer members of the compression member, the second plurality of heat transfer members of the second compression member, and the support cooperate to define a conduit that receives a flow of air to cool the first cell, the second cell, the third cell, and the further cell.

In still another example of the further embodiment, the plurality of prismatic battery cells further includes a third cell having a third terminal extending from the third cell and a fourth cell having a fourth terminal extending from the fourth cell, the support locating the plurality of prismatic cells such that the third terminal of the third cell overlaps the fourth terminal of the fourth cell; and further including a second compression member removably coupled to the support, the second compression member holding the third terminal of the third cell in contact with the fourth terminal of the fourth cell, the second compression member including a second plurality of heat sink features. In a variation thereof, the plurality of heat transfer members of the compression member, the second plurality of heat transfer members of the second compression member, and the support cooperate to define a conduit that receives a flow of air to cool the first cell, the second cell, the third cell, and the further cell.

In yet a further embodiment of the present disclosure, a method of assembling a battery assembly is provided. The method comprising the steps of holding a plurality of prismatic battery cells with a support, the support having a negative terminal and a positive terminal, the plurality of prismatic battery cells including a first cell having a first terminal extending from the first cell and a second cell having a second terminal extending from the second cell; electrically coupling the plurality of prismatic cells to the negative terminal of the support and the positive terminal of the support; electrically coupling the first terminal of the first cell to the second terminal of the second cell by overlapping the first terminal of the first cell and the second terminal of the second cell; holding the first terminal of the first cell and the second terminal of the second cell in contact with a compression member removably coupled to the support, the compression member including a plurality of heat sink features that define a conduit; and passing air through the conduit to cool the first cell and the second cell.

The above and other features of the present disclosure, which alone or in any combination may comprise patentable subject matter, will become apparent from the following description and the attached drawings.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 illustrates an exemplary battery assembly with a plurality of battery cells illustrated in FIG. 3 supported on a tray;

FIG. 1A illustrates an exemplary battery assembly with a tray including a plurality of battery cells illustrated in FIG. 3A supported on a battery support;

FIG. 1B illustrates an exemplary battery assembly with a base member and removable trays including a plurality of battery cells illustrated in FIG. 3;

FIG. 2 illustrates a top view of the exemplary battery assembly of FIG. 1 illustrating an exemplary interconnection between the plurality of battery cells and a location of a controller;

FIG. 3 illustrates an exemplary battery cell having a positive terminal and a negative terminal extending from different sides of the battery cell;

FIG. 3A illustrates an exemplary battery cell having a positive terminal and a negative terminal extending from a common side of the battery cell;

FIGS. 4 and 5 illustrate an exemplary interconnection between a pair of battery cells;

FIG. 6 illustrates an exemplary stack of battery assemblies of FIG. 2, a low voltage unit, and a high voltage unit;

FIG. 7 illustrates an exemplary stack of battery assemblies of FIG. 2, a low voltage unit, and a high voltage unit and illustrating an exemplary electrical connection between the battery assemblies and the high voltage unit; and

FIGS. 8A and 8B illustrate an exemplary rack system of the battery assemblies of FIG. 2.

FIG. 9 illustrates a representative view of another battery assembly;

FIG. 10 illustrates a perspective view of an embodiment of the battery assembly of FIG. 9;

FIG. 11 illustrates a top view of a battery support of the battery assembly of FIG. 10;

FIG. 12 illustrates a bottom view of the battery support of FIG. 11;

FIG. 12A illustrates an alternative embodiment of the battery support of FIG. 12;

FIG. 13 illustrates a top view of the battery assembly of FIG. 10;

FIG. 13A illustrates a bottom view of the battery assembly of FIG. 10 illustrating the thermal pattern across the battery assembly;

FIG. 13B illustrates an end view of an exemplary compression bar of FIG. 13;

FIG. 13C illustrates an end view of another exemplary compression bar;

FIG. 14 illustrates a sectional view of a connection region between adjacent battery cells, one of the cells shown;

FIG. 15 illustrates an enlarged end view of a portion of the connection region of FIG. 14;

FIG. 16 illustrates an enlarged view of a first portion of the top view of FIG. 13 illustrating a terminal bar;

FIG. 17 illustrates an enlarged view of a second portion of the top view of FIG. 13 illustrating a portion of a voltage monitoring system;

FIG. 18 illustrates an enlarged view of a third portion of the top view of FIG. 13 illustrating a portion of a temperature monitoring system;

FIG. 19 illustrates an enlarged view of a portion of the battery assembly of FIG. 10 illustrating the location of the temperature sensing devices of the temperature monitoring system;

FIG. 20 illustrates a perspective view of a pocket in the battery support which receives a temperature sensing device of the temperature monitoring system;

FIG. 21 illustrates a top view of the pocket of FIG. 20;

FIG. 22 illustrates a module including a plurality of battery assemblies of FIG. 10 stacked and a battery management tray positioned on top of the stacked battery assemblies;

FIG. 23 illustrates an end view of the module of FIG. 22 illustrating the electrical connectors of the module;

FIG. 24 illustrates the module of FIG. 22 with the battery management tray and connector covers unassembled from the stack;

FIG. 25 illustrates the module of FIG. 22 with the battery management tray and connector covers removed and the electrical connector interfaces unassembled from the stack;

FIG. 26 illustrates the end view of FIG. 23 with the battery management tray, connector covers, and the electrical connector interfaces removed;

FIG. 27 illustrates the opposite end view of the stack of FIG. 26;

FIG. 28 illustrates the stack of FIG. 26 with two battery assemblies unassembled from the stack;

FIG. 29 illustrates a perspective view of the top two battery assemblies of the module of FIG. 22;

FIG. 30 illustrates a bottom, perspective view of the two battery assemblies of FIG. 29;

FIG. 31 illustrates a sectional view of the two battery assemblies of FIG. 29 illustrating nesting features of the two battery assemblies;

FIG. 32 illustrates a first pair of exemplary electrical connectors of the module of FIG. 22;

FIG. 33 illustrates a second pair of exemplary electrical connectors of the module of FIG. 22;

FIG. 34 illustrates a third pair of exemplary electrical connectors of the module of FIG. 22;

FIG. 35 illustrates a rear, perspective view of an electrical connector of the module of FIG. 22;

FIG. 36 illustrates a sectional view of the electrical connector of FIG. 35;

FIG. 37 illustrates an exploded, rear perspective view of another electrical connector;

FIG. 38 illustrates a rear, exploded, perspective view of an electrical connector of the module of FIG. 22;

FIG. 39 illustrates an exemplary enclosure including a plurality of the modules of FIG. 22

FIG. 40 illustrates a top view of an exemplary battery support;

FIG. 40A illustrates a partial, top perspective view of the battery support of FIG. 40;

FIG. 41 illustrates a sectional view of the battery support of FIG. 40 along lines 41-41 in FIG. 40;

FIG. 41A illustrates a detail view of a portion of the sectional view of FIG. 41;

FIG. 42 illustrates a sectional view of the battery support of FIG. 40 along lines 42-42 in FIG. 40;

FIG. 43 illustrates a sectional view of the battery support of FIG. 40 along lines 43-43 in FIG. 40;

FIG. 44 illustrates a sectional view of the battery support of FIG. 40 along lines 44-44 in FIG. 40;

FIG. 45 illustrates a bottom view of the battery support of FIG. 40;

FIG. 45A illustrates a partial, bottom perspective view of the battery support of FIG. 40;

FIG. 46 illustrates a top perspective view of a battery assembly including a plurality of battery cells coupled to the battery support of FIG. 40 in a first configuration with a first pair of terminal jumpers along with voltage sensors and temperature sensors;

FIG. 46A illustrates a partial, top, perspective view of the battery assembly of FIG. 46;

FIG. 47 illustrates a top view of the battery assembly of FIG. 46;

FIG. 48 illustrates a top perspective view of a battery assembly including the battery assembly of FIG. 46 and a battery assembly having a plurality of battery cells in a second configuration with a second pair of terminal jumpers along with voltage sensors and temperature sensors;

FIG. 48A illustrates a partial, top, perspective view of the battery assembly of FIG. 48;

FIG. 49 illustrates a top view of the battery assembly of FIG. 48;

FIG. 49A is a detail view of a portion of the battery assembly of FIG. 49;

FIG. 50 illustrates a top perspective view of a battery assembly including the battery assembly of FIG. 48 and a battery assembly having a plurality of battery cells in a third configuration with a third pair of terminal jumpers along with voltage sensors and temperature sensors;

FIG. 50A illustrates a partial, top, perspective view of the battery assembly of FIG. 50;

FIG. 51 illustrates a top perspective view of a battery assembly including the battery assembly of FIG. 50 and a battery assembly having a plurality of battery cells in a fourth configuration with a fourth pair of terminal jumpers along with voltage sensors and temperature sensors;

FIG. 51A illustrates a partial, top, perspective view of the battery assembly of FIG. 51;

FIG. 52 illustrates a partial perspective view of a battery assembly including a first instance of the battery assembly of FIG. 51 and a second instance of the battery assembly of FIG. 51;

FIG. 53 illustrates a top, perspective view of the battery assembly of FIG. 52 and a battery management tray coupled thereto;

FIG. 53A illustrates a front, perspective view of the assembly of FIG. 53;

FIG. 54 illustrates a top view of the assembly of FIG. 53;

FIG. 55 illustrates a top, perspective view of a mounting member to support the assembly of FIG. 53 for mounting in a rack;

FIG. 56 illustrates a perspective view of a portion of the mounting member of FIG. 55 cooperating with a rail of a rack;

FIG. 56A illustrates a sectional view of FIG. 56 along lines 56A-56A in FIG. 56;

FIG. 57 illustrates an assembly including the assembly of FIG. 53 and the mounting member of FIG. 55;

FIG. 58 illustrates a perspective view of an electrical cover;

FIG. 59 illustrates a sectional view of the electrical cover of FIG. 58 along lines 59-59 in FIG. 58;

FIG. 60 illustrates a threaded coupler and terminal connection.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE DRAWINGS

The embodiments disclosed herein are not intended to be exhaustive or to limit the invention to the precise forms disclosed in the following detailed description. Rather, the embodiments are chosen and described so that others skilled in the art may utilize their teachings.

While the present disclosure primarily involves storing and providing energy for a stationary energy storage market, it should be understood, that the invention may have application to other devices which receive power from batteries. Exemplary applications for a stationary storage market include providing power to a power grid, providing power as an uninterrupted power supply, and other loads which may utilize a stationary power source. In one embodiment, the systems and methods disclosed herein may be implemented to provide an uninterrupted power supply for computing devices and other equipment in data centers. A controller of the data center or other load may switch from a main power source to an energy storage system of the present disclosure based on one or more characteristics of the power being received from the main power source or a lack of sufficient power from the main power source. In one embodiment, the systems and methods disclosed herein may be implemented to provide power to an electric vehicle or a hybrid vehicle.

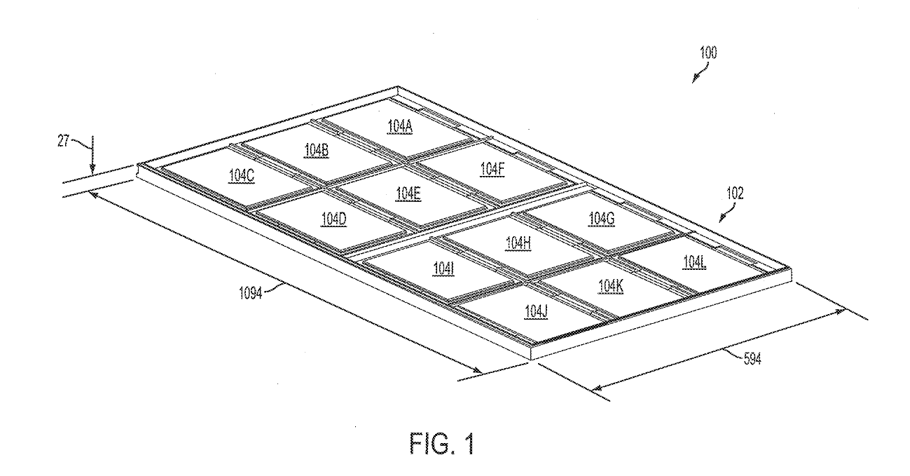

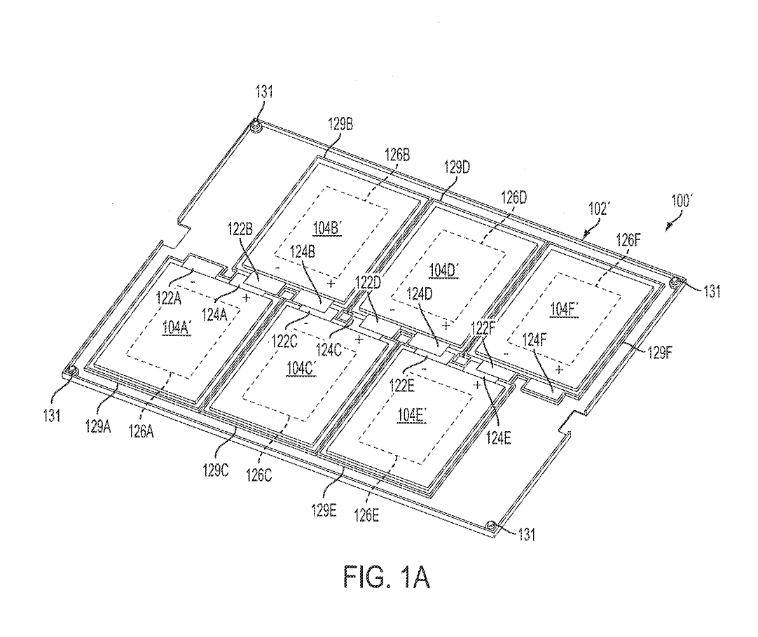

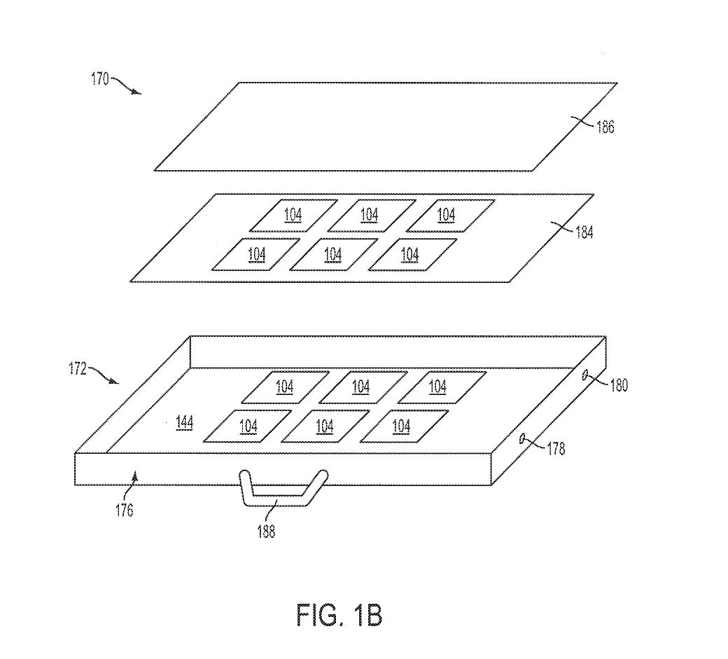

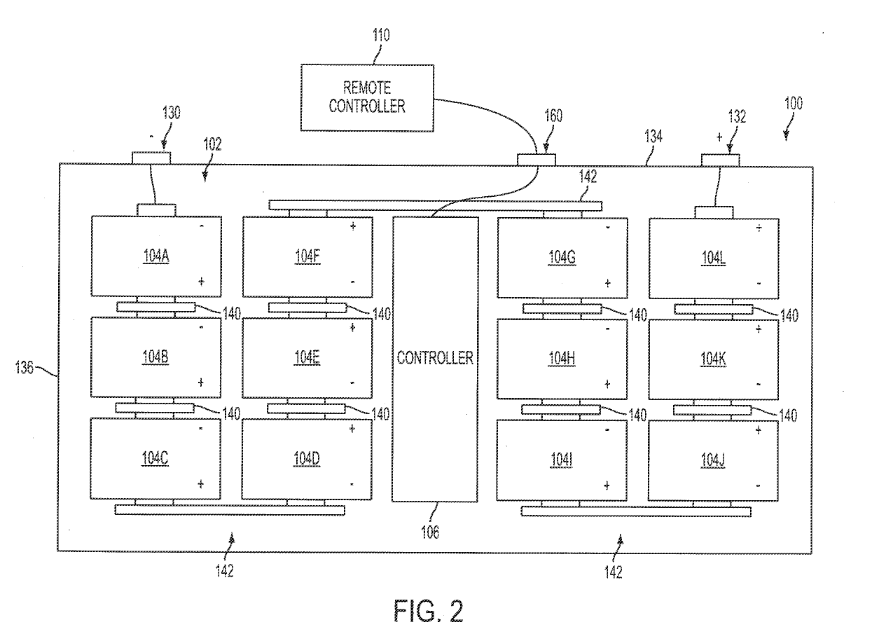

Referring to FIG. 1, a battery assembly 100 is shown. Battery assembly 100 includes a support 102 and a plurality of battery cells 104. Battery assembly 100 is also referred to herein as a tray. Battery cells 104 are supported by support 102 and are connected together to provide a source of power. In the illustrated embodiment (see FIG. 2), battery assembly 100 further includes a controller 106 which illustratively is also supported by support 102. Controller 106 is operatively coupled to battery cells 104 to monitor temperature and voltage of the battery cells 104. In one embodiment, sense leads are terminated from each cell interconnect (discussed herein with reference to FIGS. 2, 4, and 5) and routed to controller 106. In one embodiment, the number of cells 104 of battery assembly 100 preferably matches the number of channels available on controller 106.

In one embodiment, controller 106 communicates with a remote controller 110 to provide an indication of at least one of a temperature and a voltage associated with at least one battery cells 104 of battery assembly 100. In one embodiment, controller 106 communicates with remote controller 110 over a wired network. An exemplary network is a CAN network. In one embodiment, controller 106 communicates with remote controller 110 over a wireless network.

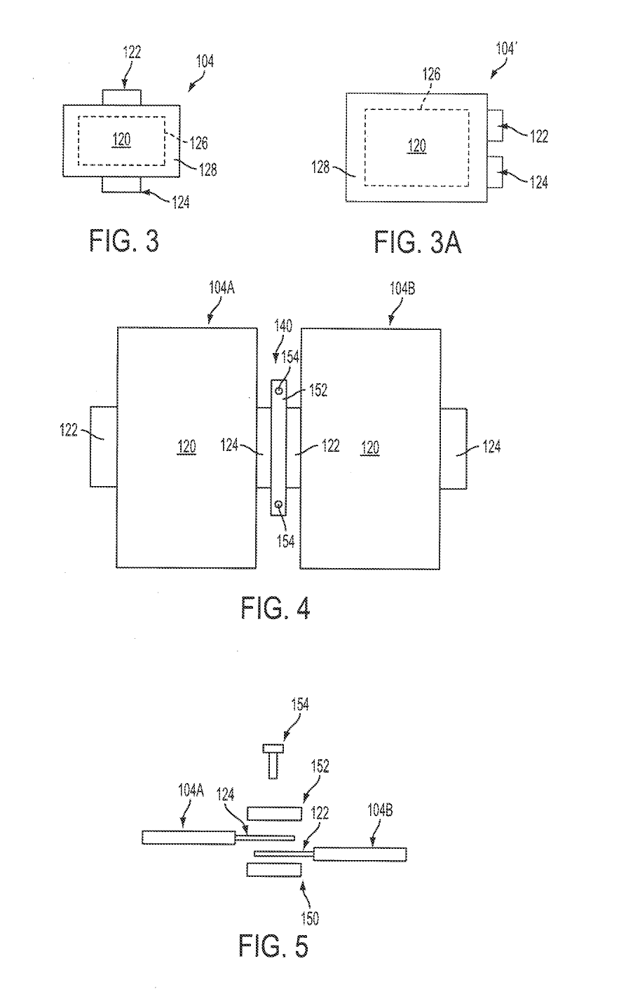

Referring to FIG. 2, a top view of battery assembly 100 is illustrated. Battery cells 104 are positioned on support 102 generally in a side-by-side arrangement in multiple rows, each row including a plurality of cells 104. Referring to FIG. 3, an illustrative cell 104 is shown. Cell 104, illustratively, is a soft prismatic cell. Battery cells 104 include a cell pouch 120 containing the battery chemistry and anode-cathode pairs. A negative terminal 122 and a positive terminal 124 extend from the interior of the cell pouch 120.

As illustrated in FIG. 2, cells 104 are positioned in a single layer in a generally flat configuration. The middle or center portions of cells 104 are spaced apart from the middle or center portions of the adjacent cells 104 such that the center portions of the cells 104 are positioned in a non-overlapping arrangement. As illustrated, at least one of the terminals 122, 124 of adjacent cells 104 do overlap to make the electrical connection between the cells 104. In one embodiment, the terminals do not overlap, but are electrically connected through one of the support 102 and an additional electrical jumper component (not shown).

Although the cells 104 illustrated in FIG. 2 form a single layer on support 102, in one embodiment, multiple layers of cells 104 may be positioned on top of support 102. In this embodiment, the middle of center portions of the cells are still arranged in a non-overlapping arrangement relative to cells 104 within the same layer, but are overlapping with cells 104 of adjacent layers.

Returning to FIG. 2, the cells 104 are connected together to form a battery group. In the illustrative embodiment, the cells 104 are connected together in series to form a single battery group. In one embodiment, the total voltage of the single battery group is less than about 50 volts. By having the voltage of battery assembly 100 be less than about 50 volts, battery assembly 100 complies with the OSHA HV threshold of 50 volts to provide safe assembly and shipping of battery assembly 100 and groups of battery assemblies 100 which are not coupled together. In another embodiment, at least two of the battery cells 104 are coupled together in parallel. In a further embodiment, the battery cells 104 are divided into multiple battery groups.

In the embodiment, illustrated in FIG. 2, a negative terminal of cell 104A is connected to a negative terminal 130 of battery assembly 100 and a positive terminal of cell 104A is connected to a negative terminal of cell 104B. (The sides of the cell 104 with the negative and positive terminals are indicated with a “−” and a “+” in FIG. 2) As illustrated a positive terminal of cell 104B is in turn connected to a negative terminal of cell 104C. This continues on through to cell 104L. A positive terminal of cell 104L is connected to a positive terminal 132 of battery assembly 100. As illustrated, the negative terminal 130 of battery assembly 100 is located on a front face 134 of battery assembly 100 and towards a first side 136. The positive terminal 132 is also located on the front face 134 and towards a second side 138. By flipping the cells 104 over on support 102, the negative terminal 130 of battery assembly 100 becomes the positive terminal and the positive terminal 132 becomes the negative terminal. Although negative terminal 130 and positive terminal 132 are shown on front face 134, negative terminal 130 and positive terminal 132 may extend from or be otherwise accessible from any surface of support 102. Further, negative terminal 130 and positive terminal 132 may be positioned on different faces of support 102.

Referring to FIG. 2, although the terminals of adjacent cells 104 are shown in an overlapping arrangement, the adjacent cells are arranged such that the middle portions are in a non-overlapping arrangement. In one embodiment, the terminals of adjacent cells 104 are arranged in a non-overlapping arrangement and are electrically connected by a connector, while the middle portions of the adjacent cells are provided in a non-overlapping arrangement.

Referring to FIGS. 4 and 5, adjacent cells 104, illustratively cells 104A and 104B, are electrically interconnected in series by overlapping and mechanically compressing the positive and negative terminals of the adjacent cells. As illustrated in FIG. 5, a first support 150 is coupled to support 102 and is positioned below the respective terminals of the cells. A second support 152 is positioned over the respective terminals of the cells. Second support 152 is coupled to first support 150 through a plurality of fasteners 154. As illustrated, fasteners 154 are threaded fasteners which may extend through apertures in second support 152 and threadably received by apertures in first support 150. Alternatively, second support 152 may be coupled to support 102 or first support 150 through snap features or any other suitable structure which holds second support 152 relative to first support 150. In one embodiment, first support 150 and second support 152 are made of hardened steel. In one embodiment, first support 150 and second support 152 are made of an electrically insulating material. Other suitable materials may be used which will create high compression at the interconnection of the cells 104.

The respective terminals of cells 104A and 104B are held in contact with each other by second support 152 pressing down on the terminals. In one embodiment, one of first support 150 and second support 152 is crowned to further assist in compressing the terminals of the respective cells 104. Returning to FIG. 2, a bussing jumper bar 142 is used to connect the respective cell terminals when terminals are not overlapped due to their position on support 102.

In one embodiment, support 102 includes molded vertical ribs which surround the cell perimeter, excluding the terminal area, to properly position the cells 104 prior to the interconnection of the terminals. These ribs also serve as features to provide the needed insulation, gap, or path for high voltage ‘Creepage and Clearance’ compliance.

In one embodiment, support 102 is made of a sheet molded composite (SMC) dielectric polymer or other suitable electrically insulating materials. An exemplary material for support 102 is DIELECTRITE E5V-204 SMC available from IDI Composites International located at 407 S. 7th Street in Noblesville, Ind. 46060. Additional details regarding DIELECTRITE E5V-204 SMC are provided in U.S. Provisional Patent Application Ser. No. 61/543,781, titled ENERGY STORAGE SYSTEM, filed Oct. 5, 2011, the disclosure of which is expressly incorporated by reference herein. Another exemplary material for support 102 is DIELECTRITE 46-16 BMC available from IDI Composites International located at 407 S. 7th Street in Noblesville, Ind. 46060. Additional details regarding DIELECTRITE 46-16 BMC are provided in U.S. Provisional Patent Application Ser. No. 61/543,781, titled ENERGY STORAGE SYSTEM, filed Oct. 5, 2011, the disclosure of which is expressly incorporated by reference herein. As mentioned herein, located on the front face 134 of battery assembly 100 are the high voltage (HV) connectors for electrical positive (terminal 132) and electrical negative (terminal 130) potentials. In one embodiment, these high voltage connectors are connected to other battery assemblies 100 to form larger battery groups. The front face 134 also includes a low voltage (LV) communication connector 160 to connect controller 106 to remote controller 110.

Exemplary dimensions for battery assembly 100 are provided in FIG. 1 in mm. A height of battery assembly 100 is about 2 percent of the length of battery assembly 100. This low profile tray design provides an electrically safe, low cost, mass/volume friendly solution for battery packaging. In one embodiment, the height of battery assembly 100 is up to about 10 percent of the length of battery assembly 100. In one embodiment, the height of battery assembly 100 is up to about 5 percent of the length of battery assembly 100. In one embodiment, the height of battery assembly 100 is up to about 1.5 percent of the length of battery assembly 100. In one embodiment, the height of battery assembly 100 is up to about 1 percent of the length of battery assembly 100.

Referring to FIG. 1A, another embodiment of battery assembly 100′ is shown. Battery assembly 100′ includes a battery support 102′ for supporting a plurality of battery cells 104′.

Referring to FIG. 3A, cell 104′ is illustrated. Cell 104′, illustratively, is a soft prismatic cell. Battery cells 104′ include a cell pouch 120 containing the battery chemistry and anode-cathode pairs. A negative terminal 122 and a positive terminal 124 extend from the interior of the cell pouch 120. Cell 104′ includes a middle portion 126 and a perimeter portion 128. In the illustrated embodiment, both the negative terminal 122 and the positive terminal 124 extend from the perimeter portion 128 of cell pouch 120. Both the negative terminal 122 and the positive terminal 124 of cell 104′ extend from a common side of the perimeter portion 128 of cell 104′.

Returning to FIG. 1A, six cells 104A-F′ are illustratively shown supported by battery support 102′. Battery support 102′ may support a fewer number or a greater number of battery cells 104′. In one embodiment, battery support 102′ extends under and supports the middle portion 126 of cells 104′.

In the illustrated embodiment, cells 104′ are arranged on battery support 102′ in a single layer. In one embodiment, multiple layers of cells 104′ are provided. Within the single layer, cell 104A′ is electrically connected to cell 104B′ which is in turn electrically connected to cell 104C′ and so on. As shown in FIG. 1A, terminal 122B of cell 104B′ overlaps terminal 124A of cell 104A′ and terminal 124B of cell 104B′ overlaps terminal 122C of cell 104C′ while the middle portion 126B of cell 104B′ remains in a non-overlapping relationship relative to middle portion 126A of cell 104A′ and relative to middle portion 126C of cell 104C′. In one embodiment, battery support 102′ holds cells 104′ in electrical contact in one of the manners described herein in relation to the other battery supports.

In one embodiment, battery assembly 100′ includes a voltage monitoring system and a temperature monitoring system. Exemplary voltage monitoring systems and temperature monitoring systems are described herein.

In the illustrated embodiment, each of cells 104′ are positioned in a corresponding pocket of battery support 102′. As shown a wall 129 is provided around each cell 104′ to provide electrical clearance related to adjacent cells 104′. Battery support 102′ includes nesting features 131 which are received in corresponding nesting features of another battery support 102′ to permit stacking of battery assemblies 100′.

Referring to FIG. 1B, another exemplary battery assembly 170 is shown. Battery assembly 170 includes a plurality of battery cells 104. In one embodiment, battery assembly 170 includes battery cells 104′. Battery assembly 170 is a portable battery assembly including a base frame 172 and a cover 186. Base frame 172 and cover 186 cooperate to define an interior of battery assembly 170 in which cells 104 are provided.

Base frame 172 includes a bottom portion 174 and a plurality of upstanding walls 176. Bottom portion 174 supports a first plurality of cells 104 which are electrically coupled together and arranged in a single layer such that the middle portions of the cells 104 are in a non-overlapping arrangement. Cells 104 are electrically coupled to a positive terminal 178 and a negative terminal 180 accessible from an exterior of battery assembly 170.

Battery assembly 170 further includes a support member 184 supporting a second plurality of cells 104 which are electrically coupled together and arranged in a single layer such that the middle portions of the cells 104 are in a non-overlapping arrangement. The cells on support member 184 are also electrically connected to positive terminal 178 and negative terminal 180. Support member 184 may be secured to one of base frame 172 and cover 186. Support member 184 is disposed within the interior defined by base frame 172 and cover 186. Although one support member 184 is shown, multiple support members may be provided.

Cover 186 is removably secured to base frame 172 to provide an enclosed interior. Base frame 172 includes a handle 188 which a user may grasp to transport battery assembly 170 from place to place. In one embodiment, covers are provided for positive terminal 178 and negative terminal 180 to prevent unintended contact to the terminals.

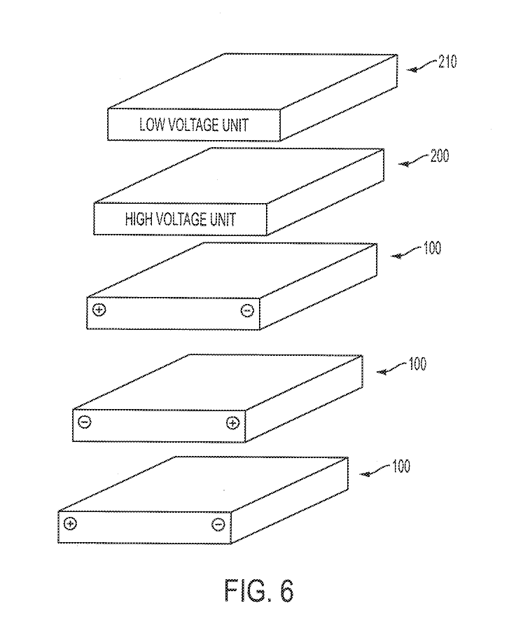

Referring to FIG. 6, a plurality of battery assemblies 100 are shown along with a high voltage tray 200 and a low voltage tray 210. High voltage tray 200 contains components such as contactors, current sensors, and fuses. Low voltage tray 210 contains components such as a Programmable Logic Controller (PLC), power supply, communication inputs/outputs. In one embodiment, high voltage tray 200 and low voltage tray 210 include the components and functionality described for the high voltage drawer and low voltage drawer in U.S. Provisional Patent Application Ser. No. 61/486,151 and PCT Application No. PCT/US11/52169, filed Sep. 19, 2011, titled ENERGY STORAGE SYSTEM, the disclosures of which are expressly incorporated by reference herein. In one embodiment, the support of high voltage tray 200 and the support of low voltage tray 210 are molded of the same SMC dielectric polymer as battery assemblies 100.

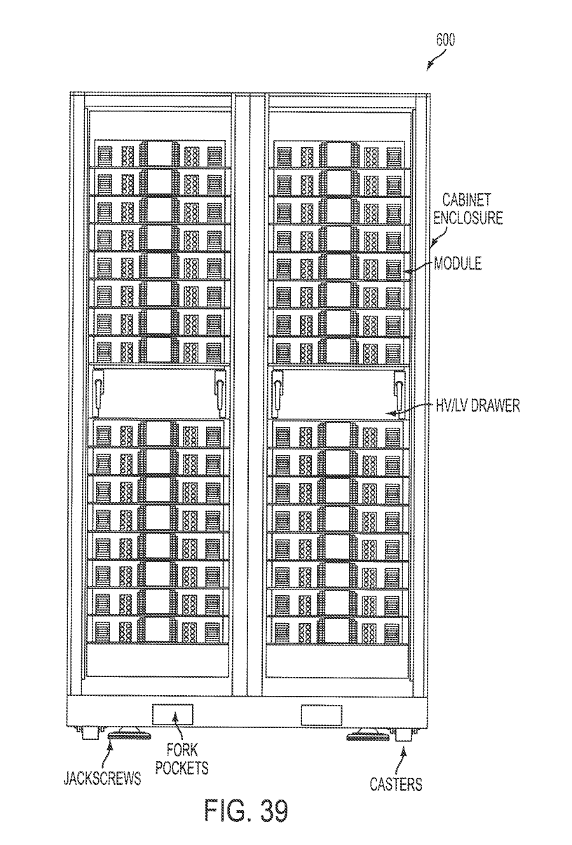

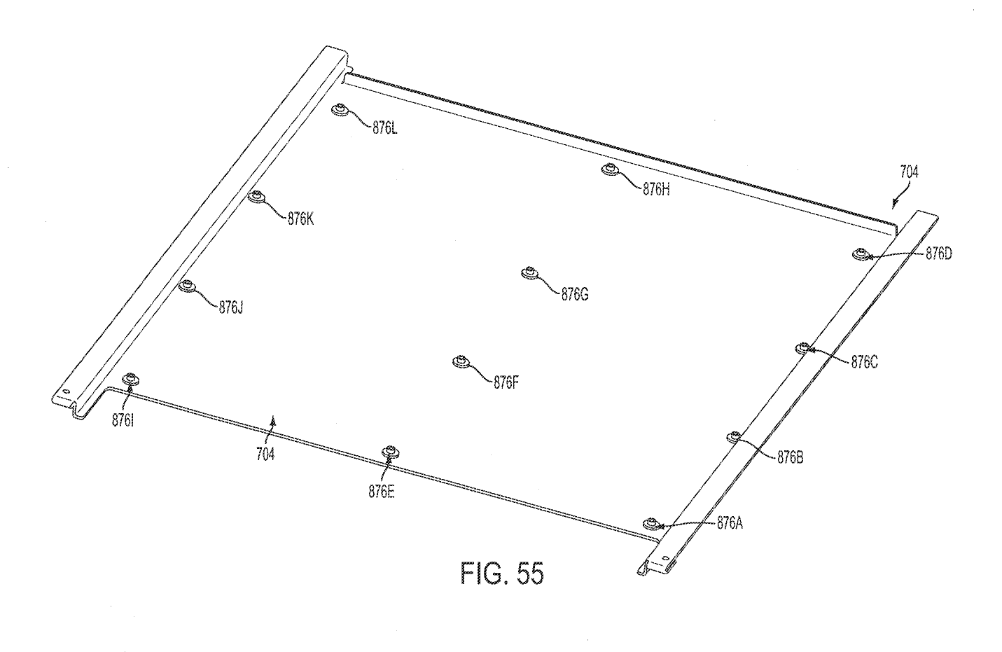

Each of battery assemblies 100, high voltage tray 200, and low voltage tray 210 contains tray-to-tray nesting features to permit the trays to be palletized and stacked. The nesting features limit the movement of a tray relative to the adjacent trays in at least one translational degree of freedom. In one embodiment, a mounting member is provided for mounting the battery assemblies in a rack. An exemplary rack system is part of the cabinet in FIG. 39. An exemplary mounting member 704 is shown in FIG. 55 in connection with battery assembly 700. A plurality of battery assemblies or trays 100, at least one high voltage tray 200, and at least one low voltage tray 210 are stacked on the mounting member. The trays are nested together. The trays are covered and banded for shipping. The trays are not electrically connected together at this point. Once received at the site, the banding and cover may be removed and electrically connectors used to interconnect at least a portion of the plurality of battery assemblies 100 and to couple the battery assemblies 100 to high voltage tray 200. The assembly of the plurality of battery assemblies 100, high voltage tray 200, and low voltage tray 210 may be arranged into the desired electrical configuration and serve as a stand-alone battery bank(s).

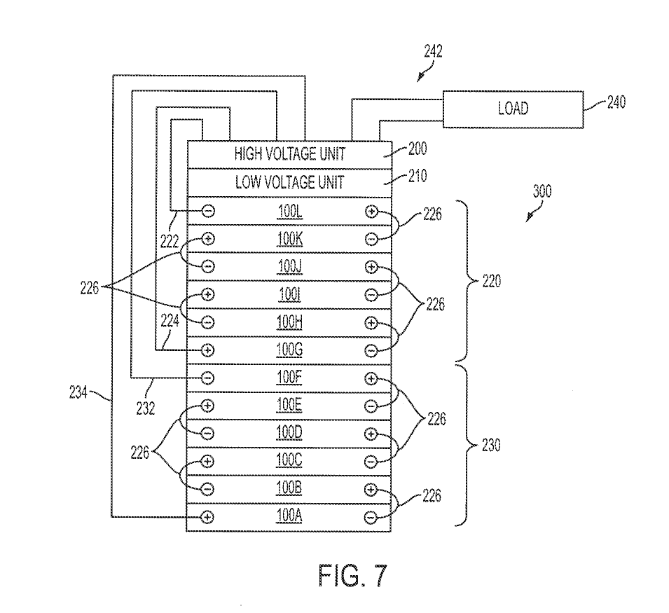

Referring to FIG. 7, an exemplary stack 300 of battery assemblies 100A-L, high voltage tray 200, and low voltage tray 210 is illustrated. The trays may be nested. In the embodiment illustrated in FIG. 7, the plurality of battery assembly 100 are split into two groups, a first group 220 (battery assemblies 100A-F) and a second group 230 (battery assemblies 100G-L). Each of the first group 220 and the second group 230 includes six battery assemblies 100. The individual battery assemblies 100 of first group 220 are interconnected with electrical cable connectors 226 coupled to the various terminals of battery assembly 100. The battery assemblies 100 are coupled together in series. A negative terminal of one of battery assembly 100 of first group 220 is coupled to high voltage tray 200 through an electrical cable connector 222. A positive terminal of one of battery assembly 100 of first group 220 is coupled to high voltage tray 200 through an electrical cable connector 224. In a similar fashion, the individual battery assemblies 100 of second group 230 are interconnected with electrical cable connectors 226 coupled to the various terminals of battery assembly 100. The battery assemblies 100 are coupled together in series. A negative terminal of one of battery assembly 100 of second group 230 is coupled to high voltage tray 200 through an electrical cable connector 232. A positive terminal of one of battery assembly 100 of second group 230 is coupled to high voltage tray 200 through an electrical cable connector 234. First group 220 and second group 230 are coupled to high voltage tray 200 in parallel. High voltage tray 200 provides power to a load 240 through lines 242. In one embodiment, high voltage tray 200 is coupled in parallel with other high voltage trays 200 (having their own battery groups coupled thereto) to load 240. Various electrical components may be provided between high voltage tray 200 and load 240. Exemplary components include inverters to convert the DC power of high voltage tray 200 into an AC power for use by load 240.

Although twelve battery assemblies 100 are illustrated in FIG. 7, any number of battery assemblies 100 may be provided. Further, the arrangement of the electrical cable connectors 226 may be altered to reduce or increase the number of battery assemblies 100 within a given battery group and to alter a number of battery groups (additional connectors to high voltage tray 200 will connect any additional battery groups to high voltage tray 200). As such, the arrangement of battery assemblies 100 may be altered based on a needed battery configuration (voltage, capacity) for the current application. By being able to vary the number of battery assemblies 100, the number of stacks 300, and the interconnection of battery assemblies 100 in a given stack, the battery arrangement may be scalable to the need of load 240.

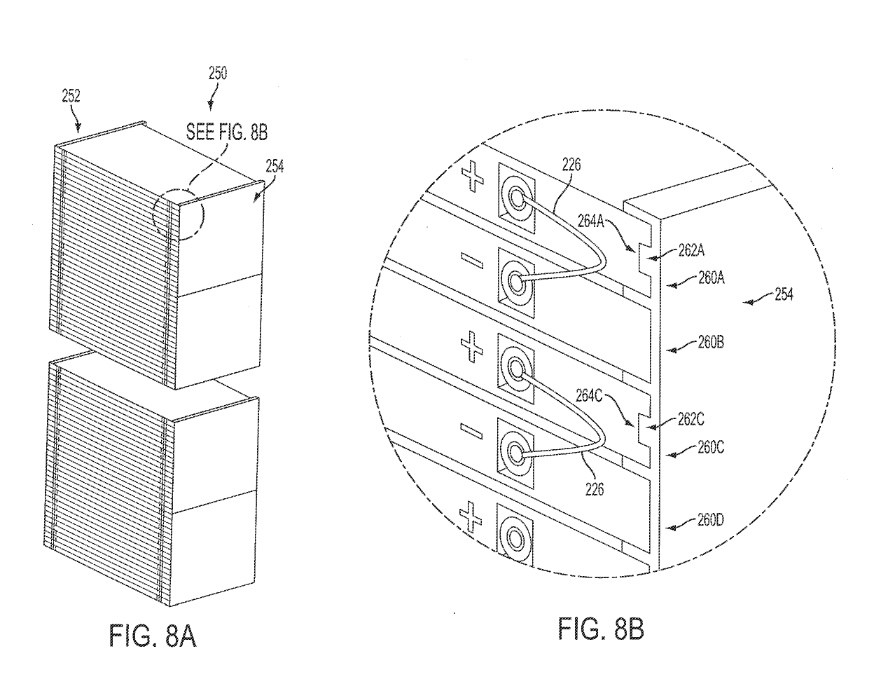

In FIG. 7, the plurality of battery assemblies 100, high voltage tray 200, and low voltage tray 210 are shown in a stack. In one embodiment, the plurality of battery assembles 100, high voltage tray 200, and low voltage tray 210 may serve as serviceable drawers in a racked system. Referring to FIG. 8, a plurality of battery assemblies 100 are illustrated mounted in a rack system 250. The rack system includes a first vertical support 252 and a second vertical support 254. Each of vertical supports 252 and 254 include a plurality of channels 260 (channels 260A-D labeled) which receive corresponding battery assemblies 100.

In one embodiment, as illustrated in FIGS. 6-8, two types of battery assemblies 100 are provided. A first version of battery assembly 100 includes negative terminal 130 and positive terminal 132 as shown in FIG. 2. A second version of battery assembly 100 includes negative terminal 130 and positive terminal 132 with their locations reversed (negative terminal 130 is in the location of positive terminal 132 in FIG. 2 and positive terminal 132 is in the location of negative terminal 130 in FIG. 2). In one embodiment (see FIG. 8), first vertical support 252 and second vertical support 254 include key features 262 (key features 262A and 262C labeled) which cooperate with corresponding key features 264 (key features 264A and 264C labeled) on battery assembly 100. The key features are one example of error proofing features for polarity configuration to assure proper battery assembly.

The plurality of battery assemblies 100 in the rack system 250 may be grouped together in various strings of battery assemblies 100, such as first group 220 and second group 230 in FIG. 7. If service is required, such as the replacement of a battery cell 104, the components in high voltage tray 200 and low voltage tray 210 may disconnect the string which the cell is a part of to isolate the string. Once this string is isolated, the quick-disconnect bussing cables 226 are removed from the tray 100 needing serviced, and the tray 100 may be removed for repair. If a given battery cell 104 needs replaced, that battery cell 104 may be removed and a replacement battery cell 104 installed therein. The tray 100 may again be reinstalled in rack system 250 and the electrical cable connectors 226 reconnected. The components in high voltage tray 200 and low voltage tray 210 may then reconnect the string for operation.

In one embodiment, tray 100 includes pins located at the rear portion of the sides 136 and 138 of support 102. The pins are received in rails of rack system 250. As discussed in U.S. Provisional Patent Application Ser. No. 61/543,781, titled ENERGY STORAGE SYSTEM, filed Oct. 5, 2011, the disclosure of which is expressly incorporated by reference herein, an operator may slide a given tray 100 forward out of rack 250, while the pins remain engaged with the rails, and rotate the battery assembly 100 downward (i.e. 45 degree) for service. Tray 100 provides direct access from the top side down to the battery cell or battery component level for fast, service-friendly repairs if needed.

At the battery's end-of-life (specified energy criteria) for a utility grid application, for example, the battery assembly 100 may be removed, stacked, shipped to a remanufacturing center, and re-configured for market into small commercial or residential uninterrupted power supply (UPS) uses.

This tray system (stacked or racked) can be provided with air, liquid, or refrigerant cooling for thermal management.

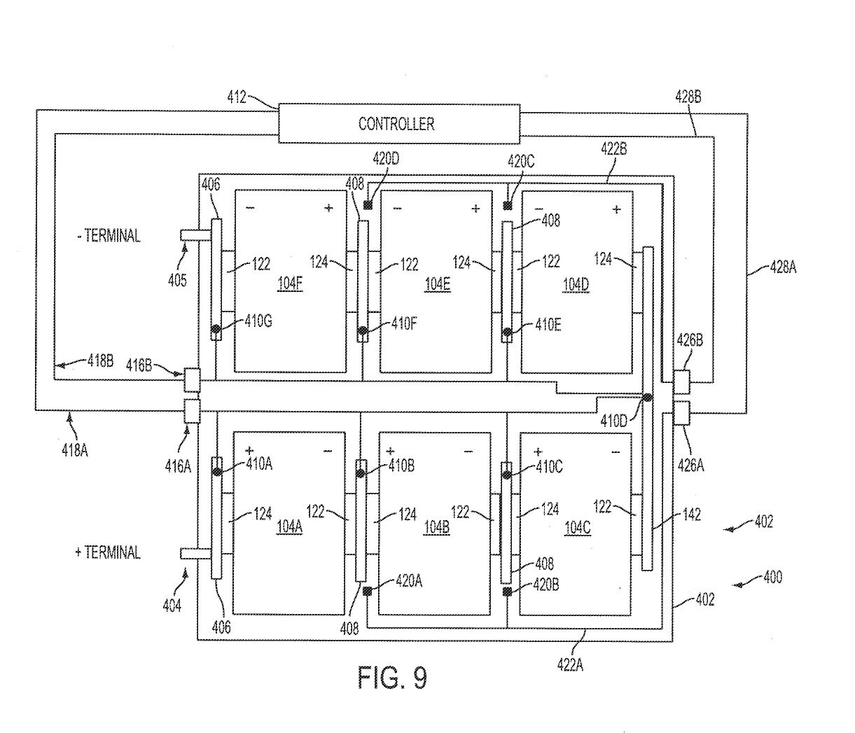

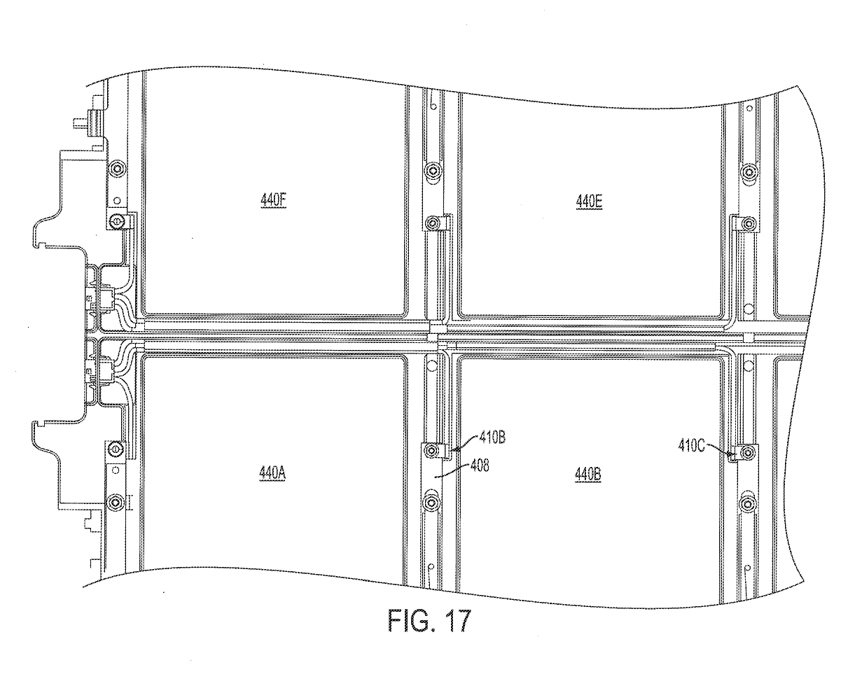

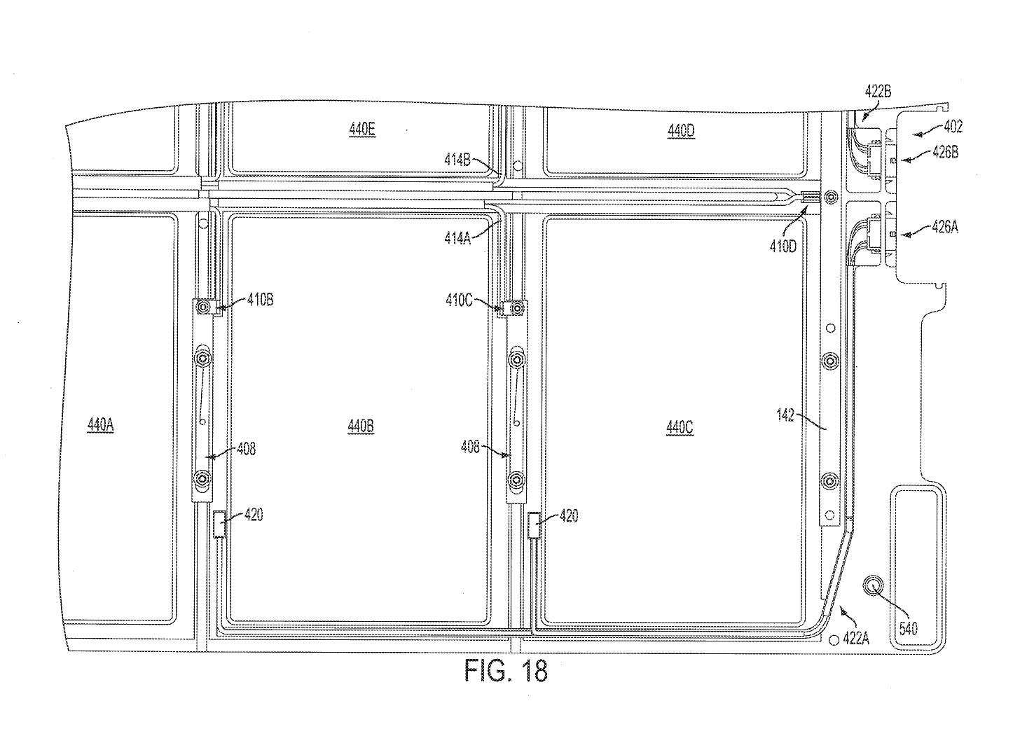

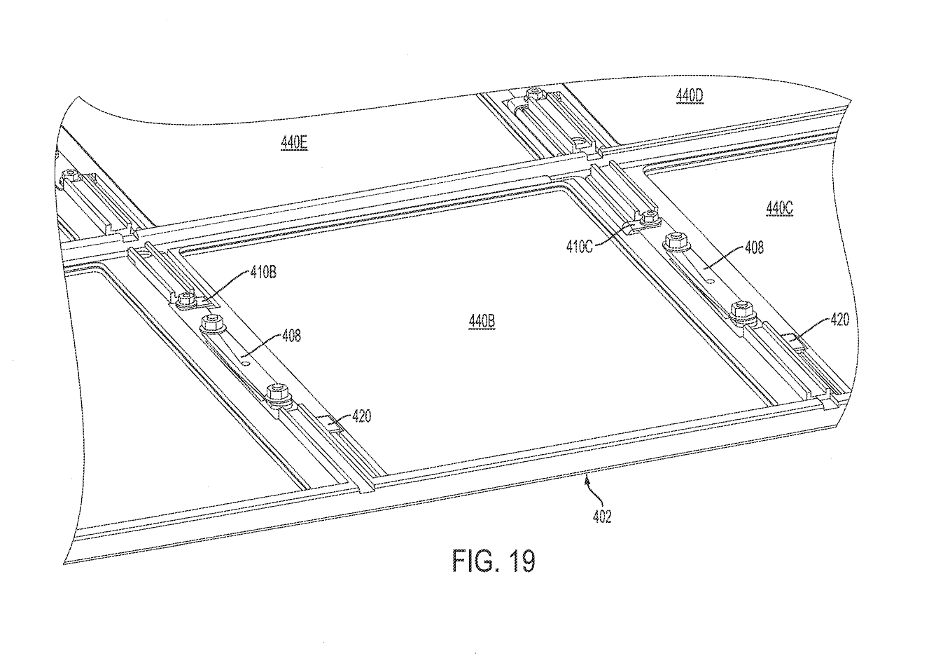

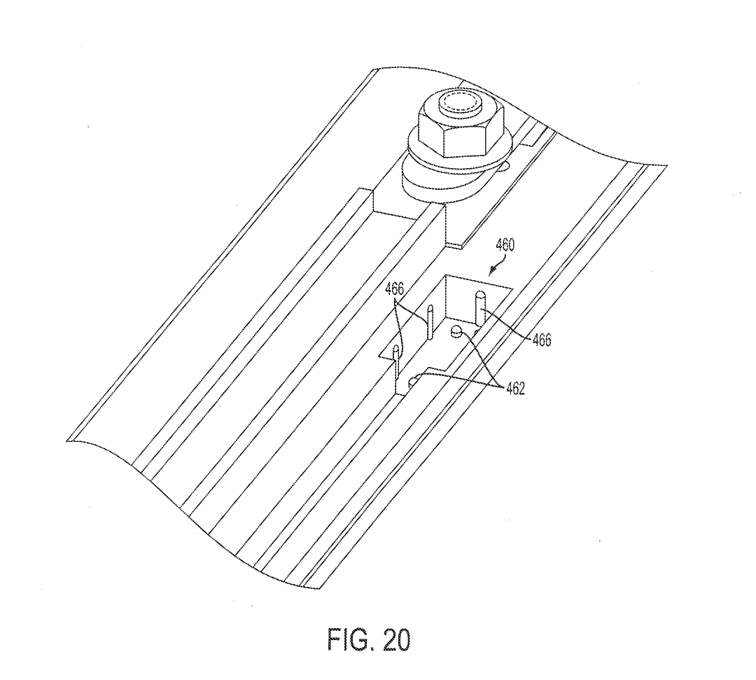

Referring to FIGS. 9-21, another exemplary battery assembly 400 is shown. battery system 400 includes a support 402 and a plurality of cells 104. In one embodiment, support 402 is made of a sheet molded composite (SMC) dielectric polymer or other suitable electrically insulating materials. An exemplary material for support 102 is DIELECTRITE E5V-204 SMC available from IDI Composites International located at 407 S. 7th Street in Noblesville, Ind. 46060. Additional details regarding DIELECTRITE E5V-204 SMC are provided in U.S. Provisional Patent Application Ser. No. 61/543,781, titled ENERGY STORAGE SYSTEM, filed Oct. 5, 2011, the disclosure of which is expressly incorporated by reference herein. Another exemplary material for support 102 is DIELECTRITE 46-16 BMC available from IDI Composites International located at 407 S. 7th Street in Noblesville, Ind. 46060. Additional details regarding DIELECTRITE 46-16 BMC are provided in U.S. Provisional Patent Application Ser. No. 61/543,781, titled ENERGY STORAGE SYSTEM, filed Oct. 5, 2011, the disclosure of which is expressly incorporated by reference herein.

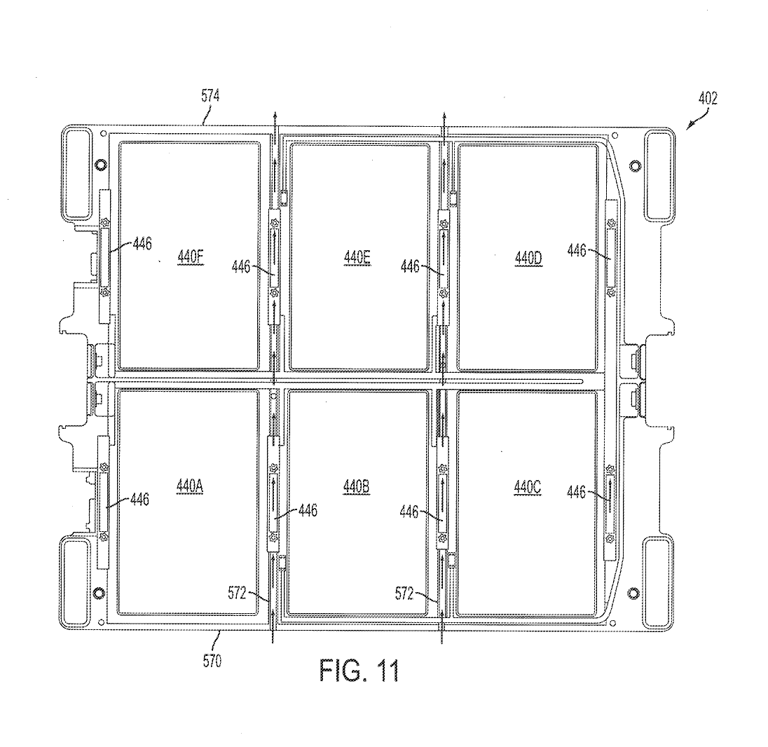

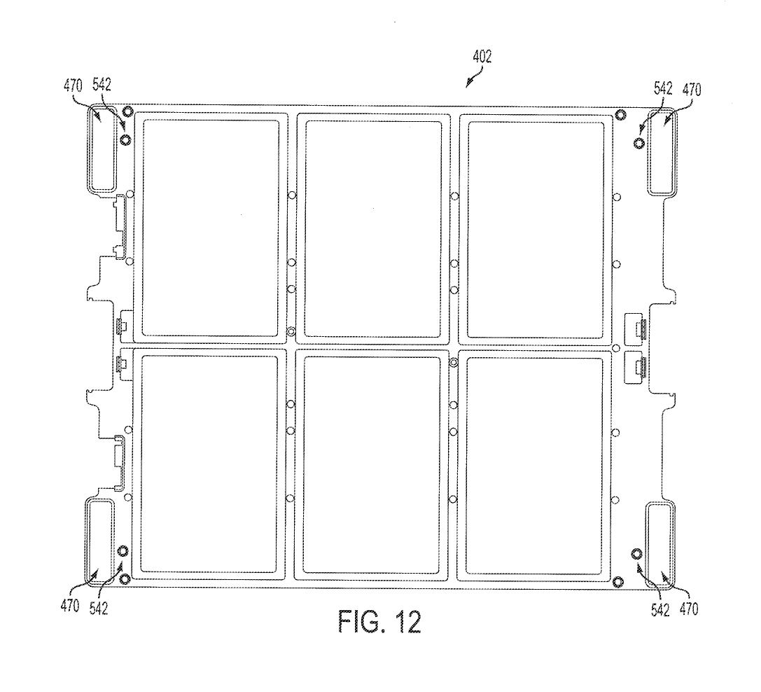

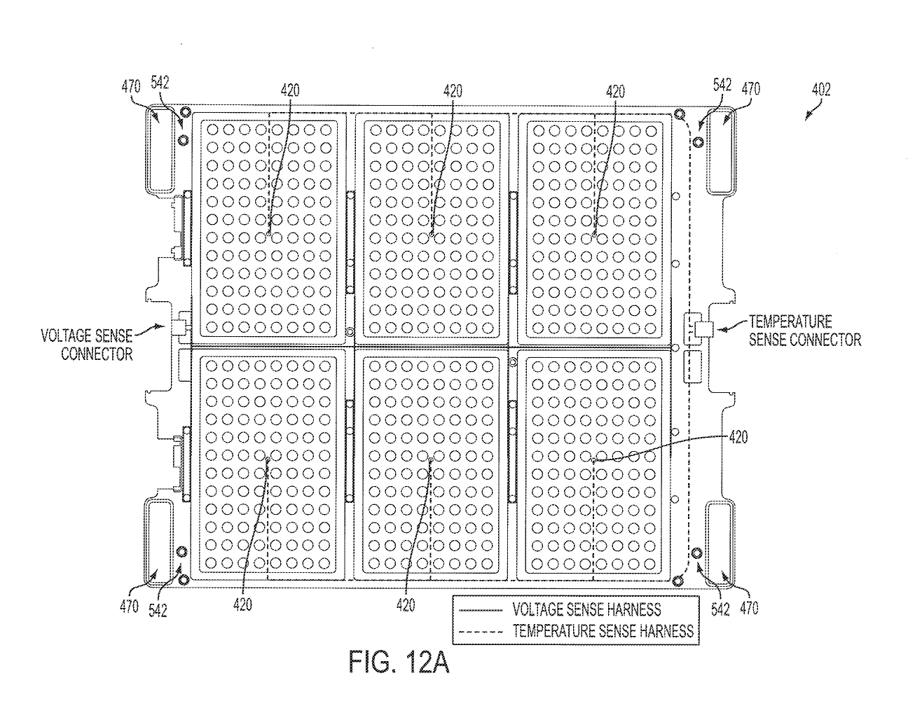

Referring to FIG. 9, support 402 supports the plurality of cells 104 thereon. In one embodiment, support 402 is generally solid in the regions underneath the plurality of cells 104 as shown in FIGS. 11 and 12. In one embodiment, support 402 includes a plurality of apertures in the regions underneath the plurality of cells 104. An exemplary support 102′ including a plurality of apertures is illustrated in FIG. 12A.

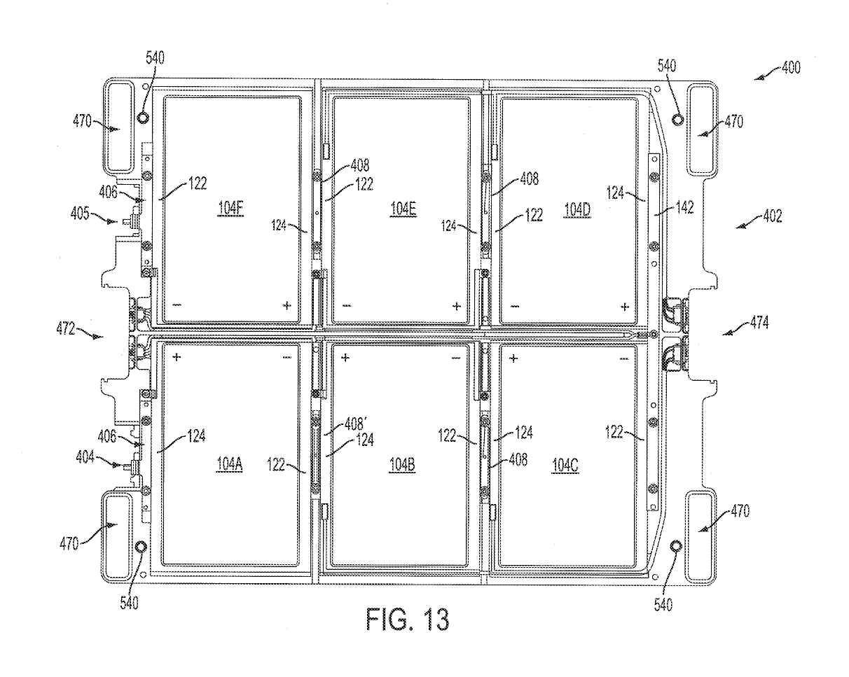

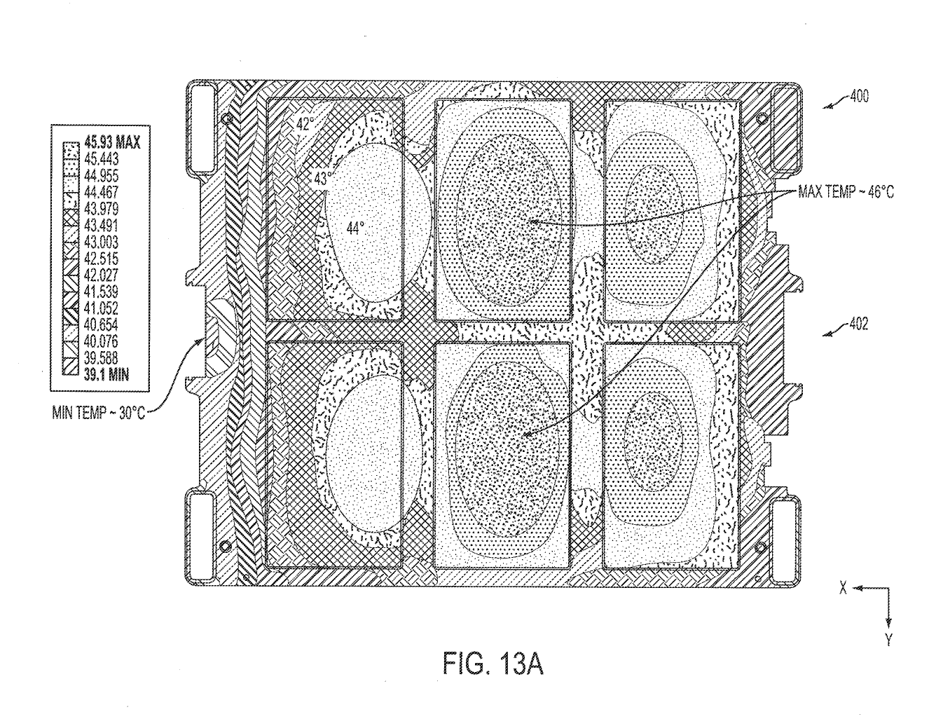

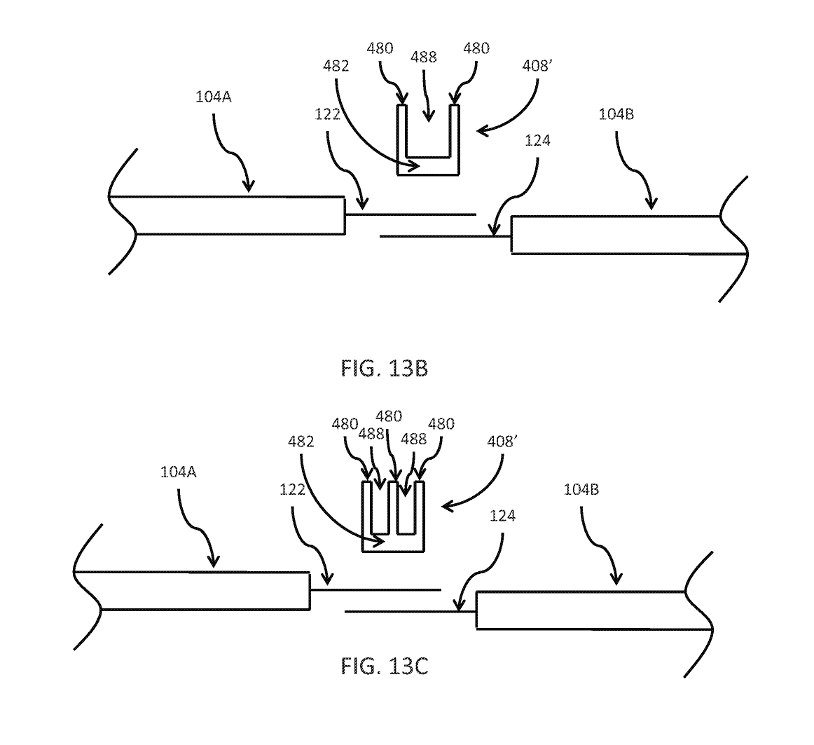

As shown in FIGS. 9 and 13, the plurality of cells 104 are arranged in a generally side-by-side arrangement. Six battery cells 104 arranged in two rows are shown in the illustrated embodiment. Other numbers and arrangements of battery cells 104 are contemplated. battery cells 104 are prismatic cells.

In the illustrated embodiment, the plurality of cells 104 are electrically coupled together in series. In one embodiment, one or more cells 104 of the plurality of cells 104 may be electrically coupled in parallel. Referring to FIG. 9, each cell 104 has a negative terminal 122 and a positive terminal 124 extending out of a pouch. The positive terminal of cell 104A is coupled to a positive terminal 404 of battery assembly 400 through a terminal bar 406. The negative terminal 122 of cell 104A is coupled to a positive terminal 124 of cell 104B through an overlapping arrangement of the terminals. Cells 104B and 104C, cells 104D and 104E, and cells 104E and 104F are electrically coupled together in the same fashion. Cells 104C and 104D are electrically coupled together through a bussing jumper bar 142. Cell 104F is coupled to a negative terminal 405 of battery assembly 400 through a terminal bar 406.

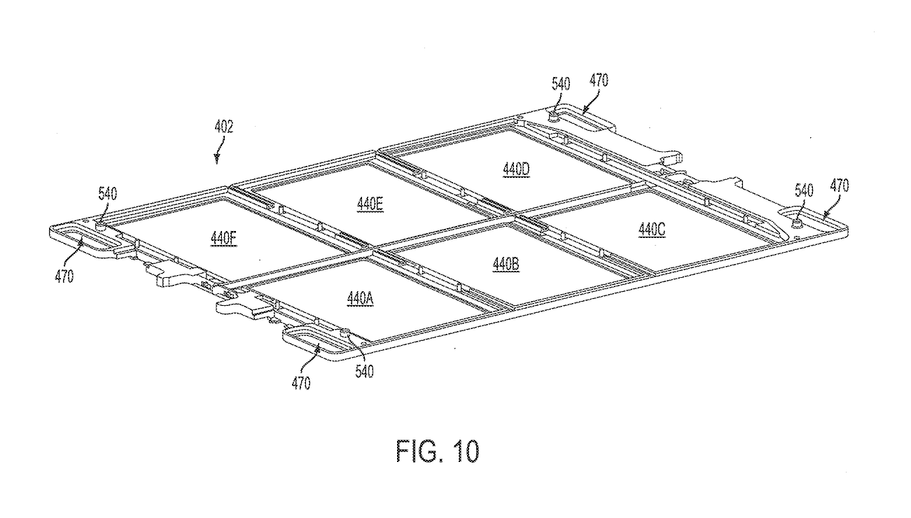

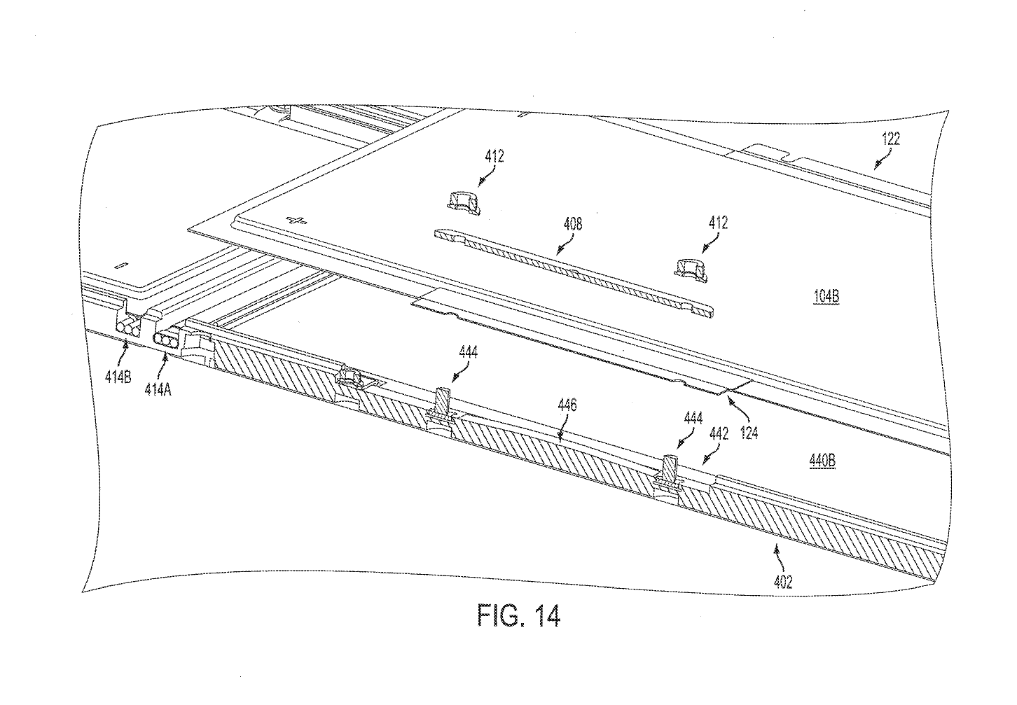

Referring to FIG. 11, support 402 includes pockets 440 to receive the corresponding cells 114. As shown in FIGS. 10 and 14, the walls surrounding the pockets 440 include breaks in the areas that the cells are electrically coupled to each other, the terminals 404 and 405, and bussing jumper bar 142. Referring to FIG. 14, a recess 442 corresponding to the region between pocket 440A and 440B is shown. As illustrated in FIG. 14, a pair of studs 444 are insert molded into support 402 or otherwise coupled to support 402. Terminal 124 of cell 104B and terminal 122 of cell 104A (not shown) include apertures which receive studs 444. In the illustrated embodiment, the apertures are open-ended.

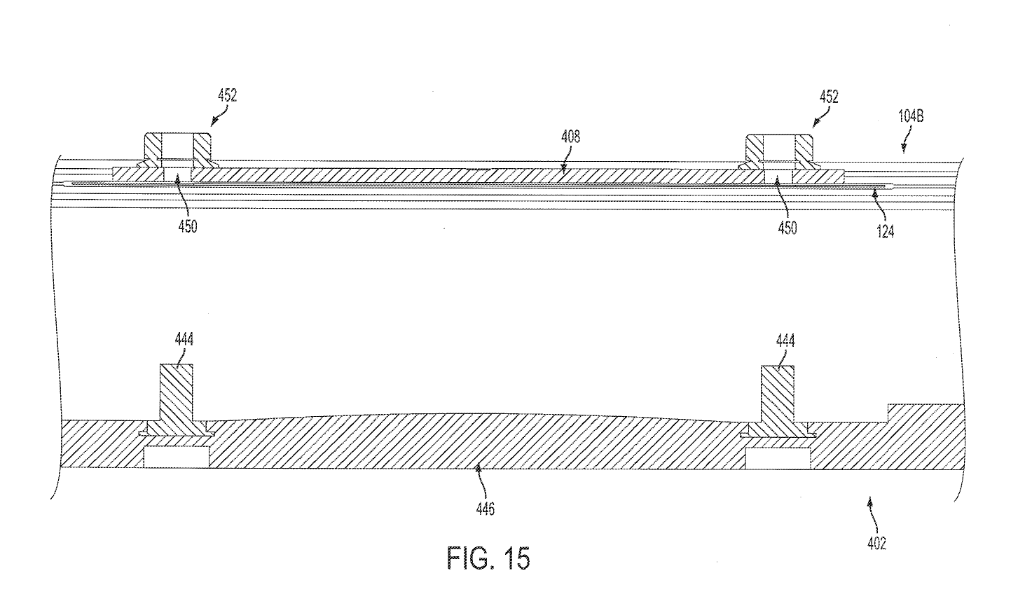

The terminals 122 and 124 rest on support 402 in region 446. As shown in FIG. 15, region 446 is crowned. A compression bar 408 is placed over terminals 122 and 124 and also includes apertures 450 which receive studs 444. Compression bar 408 presses negative terminal 122 and positive terminal 124 into contact when fasteners 452 are threaded down onto studs 444. The crowning of region 446 assists in placing and keeping negative terminal 122 and positive terminal 124 in electrical contact. Referring to FIG. 11, support 402 includes a crowned section at each of the locations that a terminal of one of the cells 102 makes an electrical connection with another cell, terminal bar, or jumper bar.

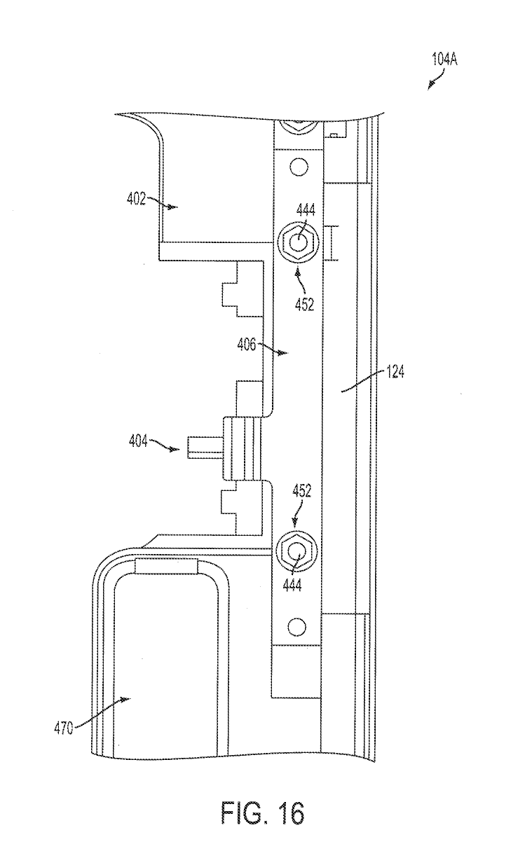

Referring to FIG. 16, the terminal bar 406 corresponding to positive terminal 404 is shown. Terminal bar 406, like compression bars 408, is pressed against the terminal 124 of the adjacent battery cell 104A and held in place with fasteners 452 tightened to studs 444. The same component is used for both the terminal bar 408 corresponding to the positive terminal 404 and the terminal bar corresponding to the negative terminal 405 and is flipped from tray to tray.

Referring to FIG. 9, an electrical connection 410 is made at each junction between the cells 104 and the terminals of the tray 400. The electrical connections 410 provide a voltage reading to a controller 412 through respective wiring harnesses 414 (see FIG. 14). The wires of the wiring harnesses 414A ad 414B terminate at connectors 416A and 416B. Cabling 418 connects connectors 416 to controller 412. In one embodiment, tray 400 includes a controller which communicates the voltage readings wirelessly to controller 412. In one embodiment, controller 412 is located in a low voltage tray which is provided as part of the battery assembly 100.

Assuming battery cells 104 are functioning properly, controller 412 should read a voltage corresponding to connection 410A that is the positive terminal voltage for tray 400. The voltage at connection 410B should generally be offset from the voltage of connection 410A by the expected voltage of cell 104A and so on through connections 140C-G.

Returning to FIG. 9, a plurality of thermistors 420 are also supported by support 402 and positioned to provide a indication of the temperature of adjacent cells 104. In FIG. 9, the thermistors 420 are positioned in a non-overlapping relationship with the cells 104. In one embodiment, shown in FIG. 12A, the thermistors are positioned under the respective cells. The thermistors 420 are coupled to controller 412 through respective wiring harnesses 422. The wires of the wiring harnesses 422A and 422B terminate at connectors 426A and 426B. Cabling 428 connects to connectors 426 to connect the connectors 426 to controller 412. In one embodiment, tray 400 includes a controller which communicates the temperature readings wirelessly to controller 412.

Referring to FIG. 18, two of thermistors 420 are shown received in corresponding pockets 460 (see FIG. 20) in support 402. The thermistors are generally located proximate to compression bar 408. The terminals 122 and 124 of the cells 104 are generally the warmest portions of the cells 104. As such, the thermistors 420 are positioned generally proximate to the warmest portions of the cells 104.

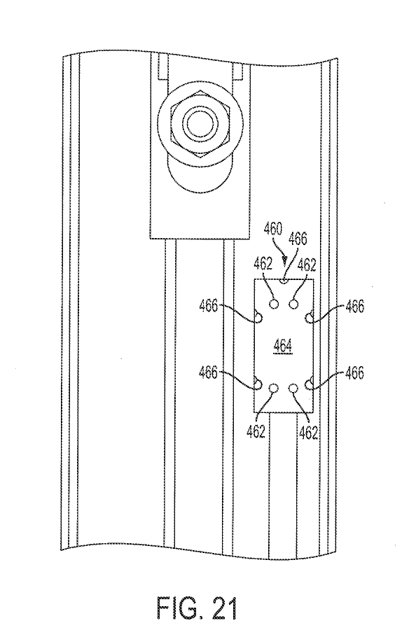

Referring to FIGS. 20 and 21, each pocket 460 includes a plurality of standoffs 462 which keep the thermistor 420 from resting on lower surface 464 of pocket 460. This reduces the thermal connection between the support 402 and thermistors 420. Further, each pocket 460 includes a plurality of standoffs 466 which keep the thermistor 420 from resting against a side surface of pocket 460. This further reduces the thermal connection between the support 402 and thermistors 420. The inclusion of standoffs 462 and 466 increases the thermistor sensitivity to the temperature of the cell 104, as opposed to the temperature of support 402. Standoffs 466 further include a lead-in profile to guide thermistor 420 as it is being lowered into pocket 460. In one embodiment, instead of standoffs 462 and 466, pocket 460 includes foam to support the thermistor and insulate the thermistor from support 402.

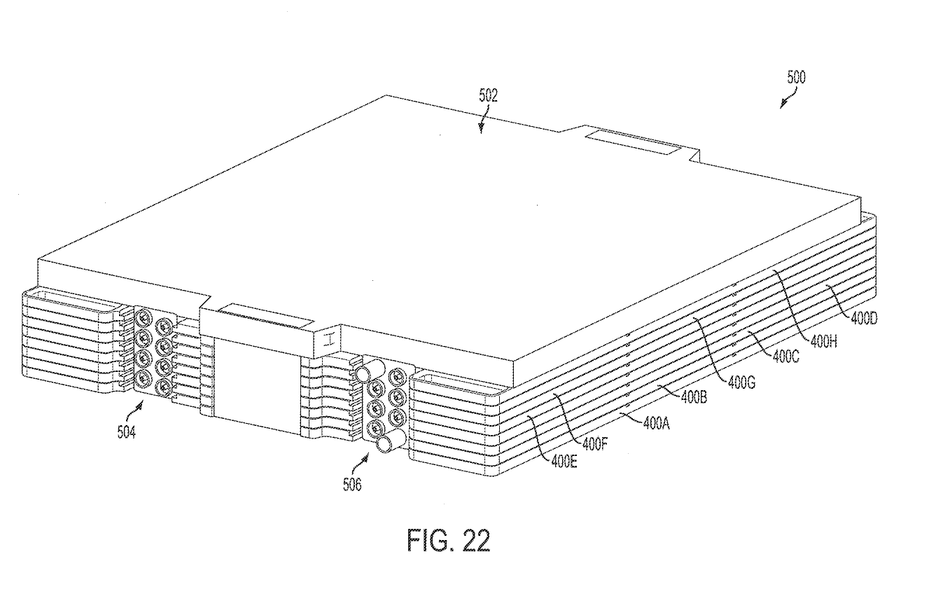

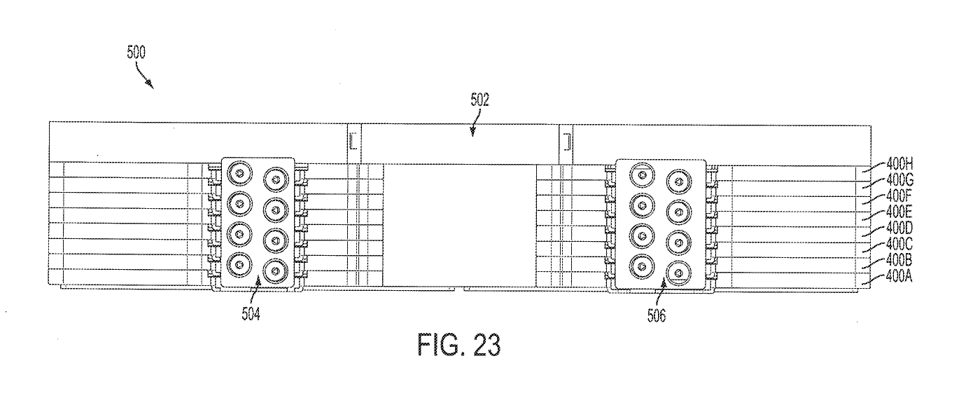

Referring to FIG. 13, battery assembly 400 includes a plurality of handles 470. Handles 470 define the envelope of battery assembly 400 on a first end 472 and a second end 474. The electrical connectors 416 are provided on the first end 472 and the temperature connectors 426 are provided on the second end 474. As shown in FIG. 22, when a plurality of battery assemblies 400 are stacked together, the handles 470 of each battery assembly 400 are generally aligned. Since handles 470 define the envelope of battery assembly 400 along first end 472 and second end 474, a battery module 500 may be stood on end without stressing connectors 416 or connectors 426.

Referring to FIG. 22, eight battery assemblies 400 are stacked together to form a battery module 500. Battery module 500 further includes a battery management tray 502 housing controller 412. In one embodiment, multiple controllers 412 are included in battery management tray 502, each coupled to one or more of the connectors 416 and 418 of one or more of battery assembly 400. Battery module 500 further includes a first electrical connector 504 and a second electrical connector 506. As explained herein, first electrical connector 504 and second electrical connector 506 couple the batteries of multiple battery assemblies 400 together in series and provide the input and output terminal connections (connector 506) for battery module 500.

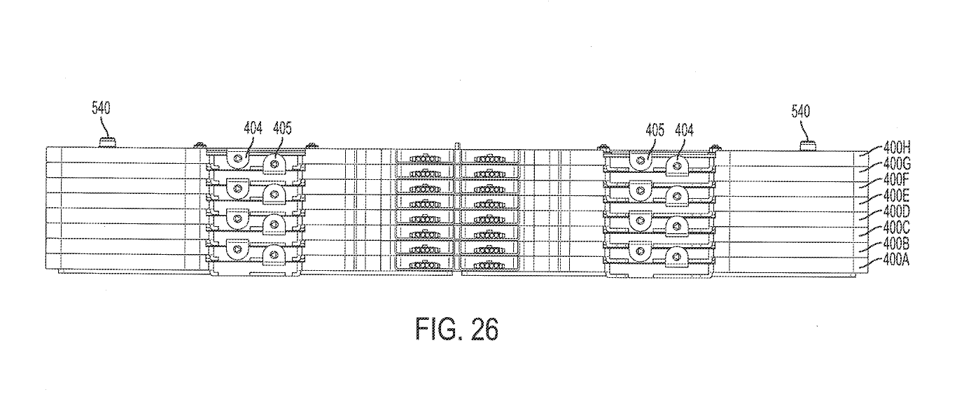

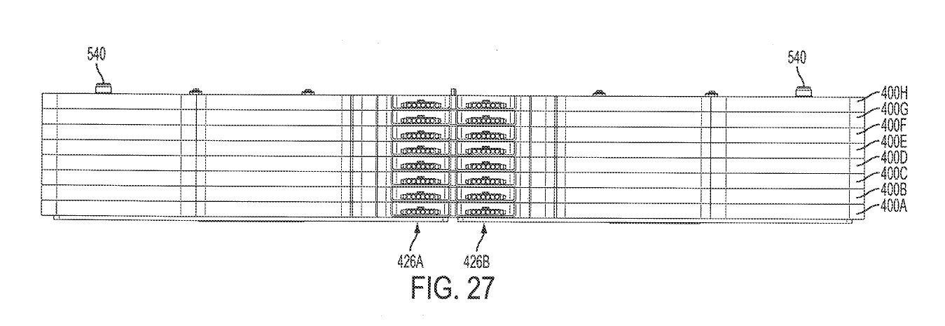

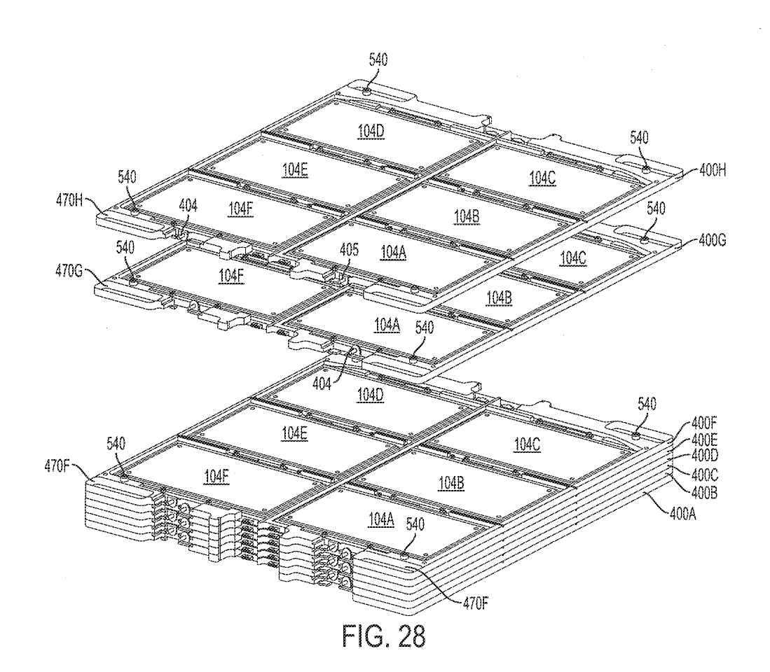

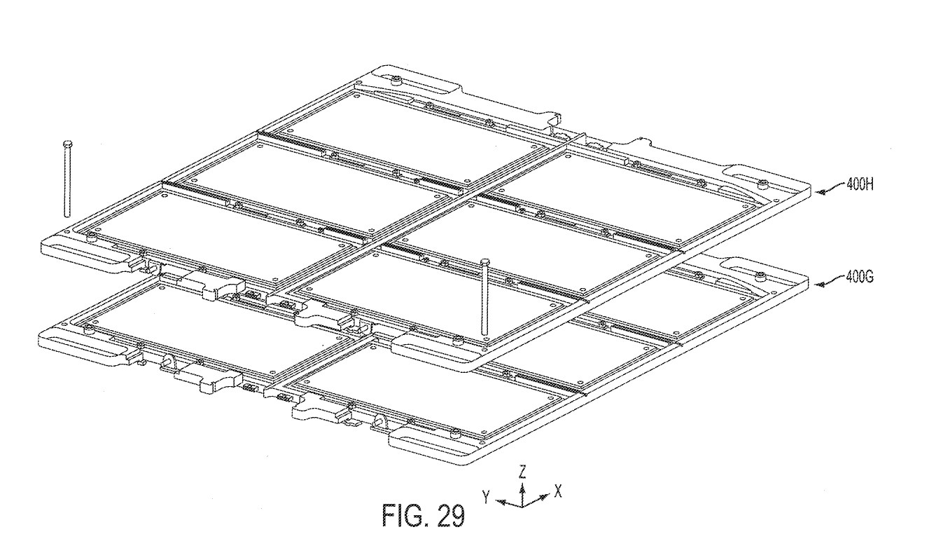

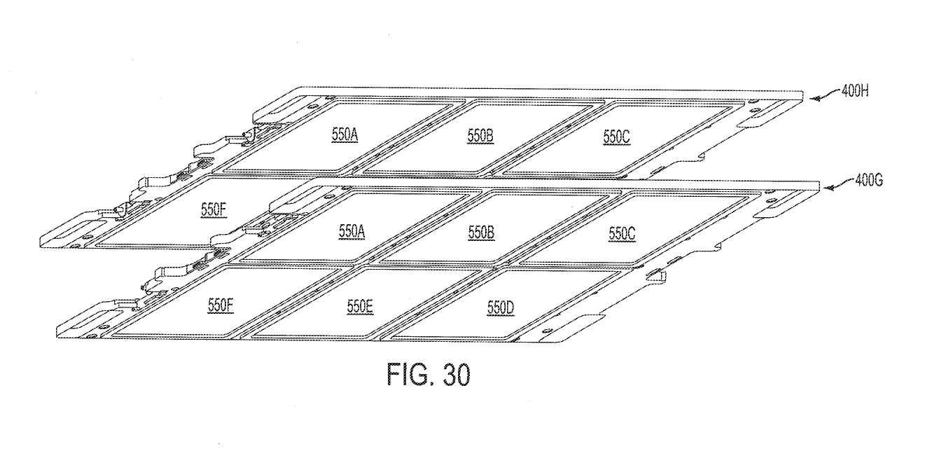

Referring to FIG. 28, the battery assemblies 400 are provided in two configurations. In a first configuration, positive terminal 404 is coupled to cell 104F and negative terminal 405 is coupled to cell 104A. In a second configuration, positive terminal 404 is coupled to cell 104A and negative terminal 405 is coupled to cell 104F. As shown in FIG. 28 and in FIG. 26, the terminal bar 406 is oriented to having a downward extending terminal for battery assembly 400H and is oriented to have an upward extending terminal for battery assembly 400G. As can be seen in FIG. 26, positive terminal 404 of battery assembly 400H is located proximate to the negative terminal 405 of battery assembly 400G and so through the stack.

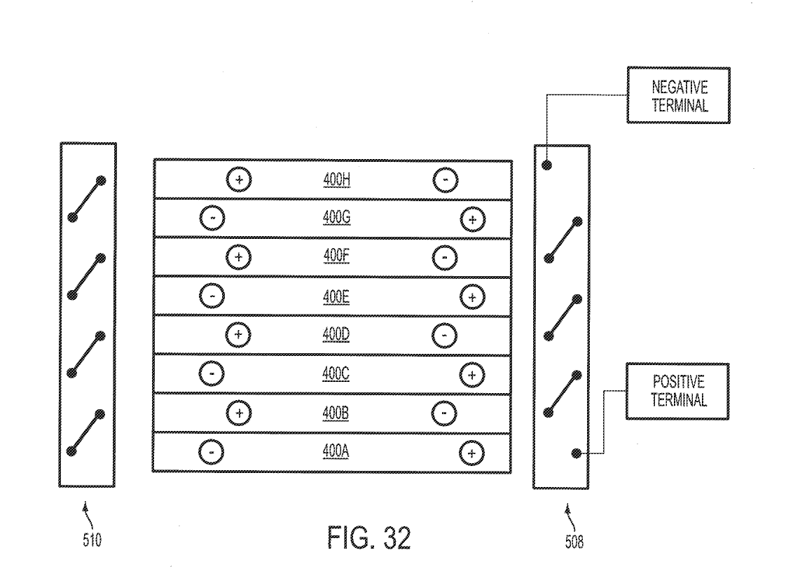

Referring to FIGS. 32-34 various configurations of battery assemblies 400 are shown. In these illustrated embodiment, battery assembly 400A has its positive terminal on the right and its negative terminal on the left.

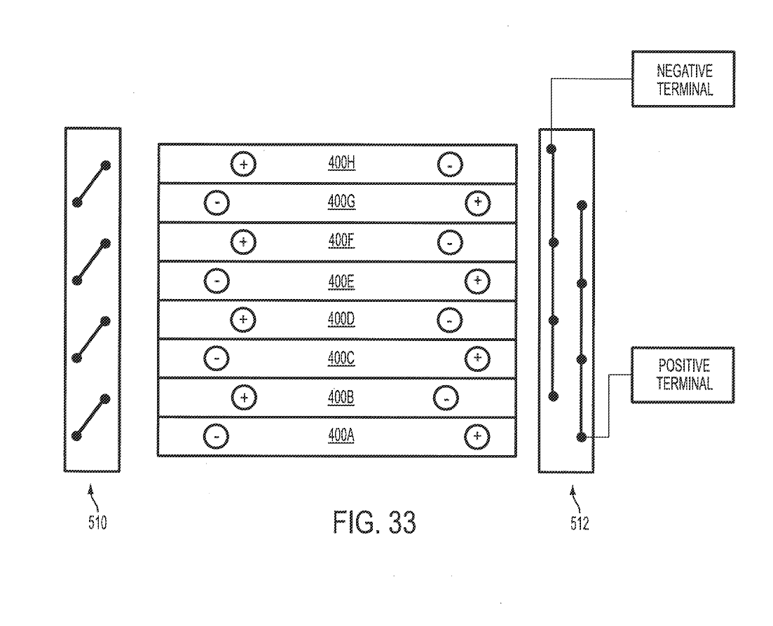

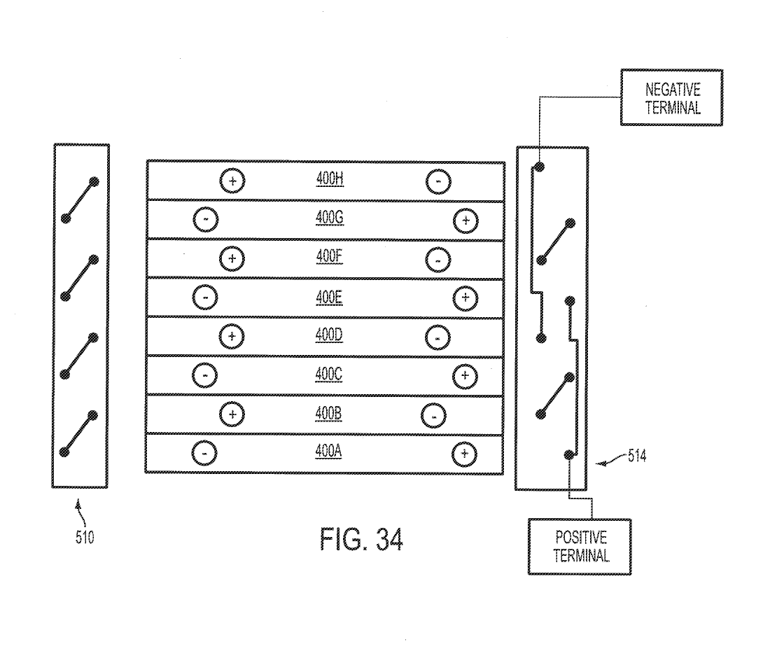

In FIG. 32, each of battery assemblies 400A-H are connected together is series with connectors 508 and 510. This results in forty-eight cells being coupled together in series. Assuming the voltage of the cells 104 is nominally 4 volts, this configuration results in a 192 volt system. In FIG. 33, every two trays 400 are connected together in series and the four pairs of trays are connected together in parallel. This configuration results in four parallel groups (two trays each) of batteries with each group including twelve cells in series. Assuming the voltage of cells 104 is nominally 4 volts, the illustrated configuration results in a 48 volt system. In FIG. 34, two groups of four trays are provided. Each group including 24 cells coupled together in series. The two groups are then coupled together in parallel. Assuming the voltage of the cells 104 is nominally 4 volts, this configuration results in a 96 volt system. By adjusting one or more of the battery orientations on respective trays 400 and/or the connectors, it is possible to produce other configurations.

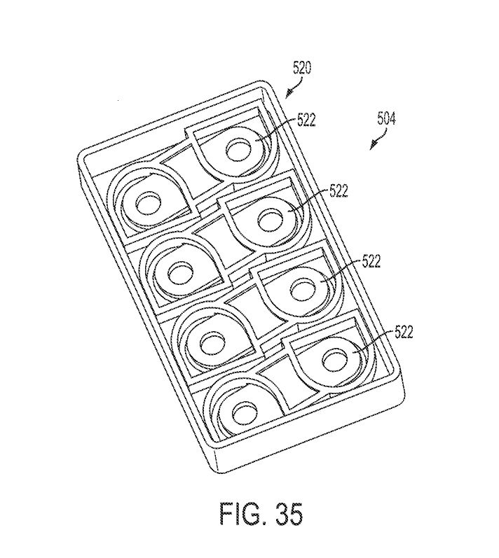

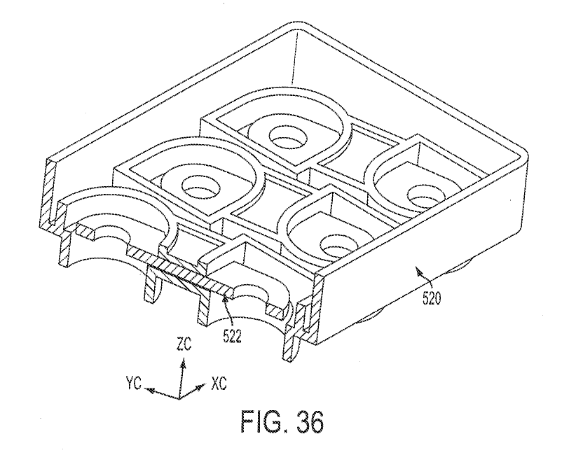

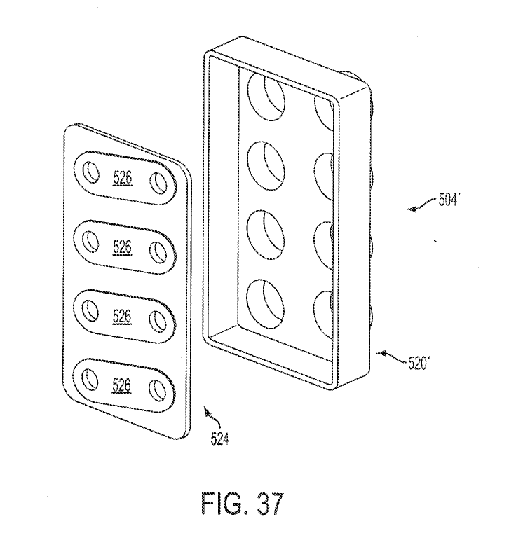

Referring to FIGS. 35 and 36, first electrical connector 504 is shown. First electrical connector 504 includes a base member 520 and a plurality of electrical connectors 522. Each electrical connector 522 connects together the terminals of adjacent battery assemblies 400. Electrical connectors 522 are over molded as part of base member 520. In one embodiment, the base member 520 includes a plurality of snap features to secure electrical connectors 522 to base member 520. Referring to FIG. 37, alternative embodiment of electrical connector 504′ is shown. Electrical connector 504′ includes a base member 520′ and a connector member 524. Connector member 524 includes a plate, such as a circuit board material, having a plurality of spaced apart conductive portions 526 thereon which connect together the terminal of adjacent battery assembly 400.

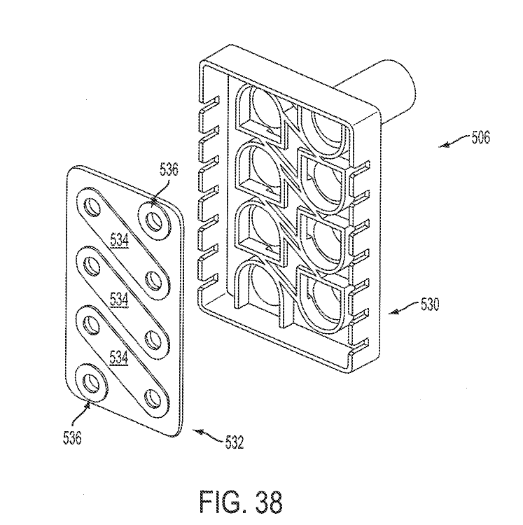

Referring to FIG. 38, an embodiment of second electrical connector 506 is shown. Second electrical connector 506 includes a base member 530 and a connector member 532. Connector member 532 includes a plate, such as a circuit board material, having a plurality of spaced apart conductive portions 534 thereon which connect together the terminal of adjacent battery assembly 400. Also provided as part of connector member 532 are copper vias 536 which extend completely through connector member 532. Copper vias 536 couple the terminal of the corresponding battery assembly 400 to a terminal stud for battery module 500.

In one embodiment, the positive terminal 404 and negative terminal 405 of battery assembly 400 receive a fastener, such as a threaded fastener to tighten first electrical connector 504 and second electrical connector 506 against the positive terminal 404 and negative terminal 405. In one embodiment, positive terminal 404 and negative terminal 405 include apertures or recesses to receive posts carried by first electrical connector 504 and second electrical connector 506. The posts may then be threaded into the apertures or recesses to coupled first electrical connector 504 and second electrical connector 506 to positive terminal 404 and negative terminal 405. In both embodiments, positive terminal 404 and negative terminal 405 contact the conductive members of first electrical connector 504 and second electrical connector 506.

In one embodiment, first electrical connector 504 and 506 are designed so that they may not be inadvertently placed in the opposite location. In one embodiment, second electrical connector 506 is wider than first electrical connector 504 and will not fit in the space provided for first electrical connector 504. In one embodiment, battery assembly 400 and/or first electrical connector 504 and second electrical connector 506 include key features which mate when the proper connector is positioned relative to battery assembly 400 and block the advancement of the wrong connector.

In one embodiment, a separate shipping connector (not shown) is provided. The shipping connector is placed over terminal 404 and 405 when battery module 500 is being shipped. The shipping connector does not make electrical connections between the battery assemblies 400, but provides protection from accidental coupling of the terminals.

If only one of first electrical connector 504 and second electrical connector 506 is removed from battery module 500, battery module 500 is broken down into subsections wherein at most two battery assemblies 400 are coupled together. Assuming that battery cells 104 are nominally 4 V cells each subsection is under 50 V. If both of first electrical connector 504 and second electrical connector 506 are removed then each battery assembly 400 is a stand alone subsection with a voltage under 25 V.

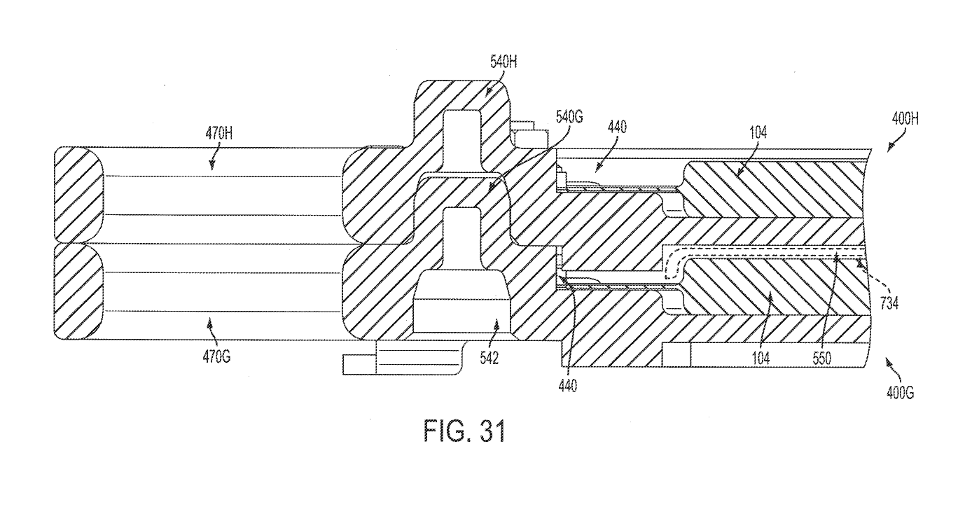

Referring to FIG. 10, support 402 includes locators 540, illustratively bosses. Locators 540 are received in corresponding locators 542, illustratively recesses, of the adjacent support 402 when battery module 500 is assembled (see FIG. 31). Locators 540 and locators 542 assist in holding battery module 500 together. Referring to FIG. 31, additional nesting features are provided relative to the cell pockets 440. Battery module 500 is held together with bolts which pass through the battery assemblies and couple the battery assemblies and battery management tray together.

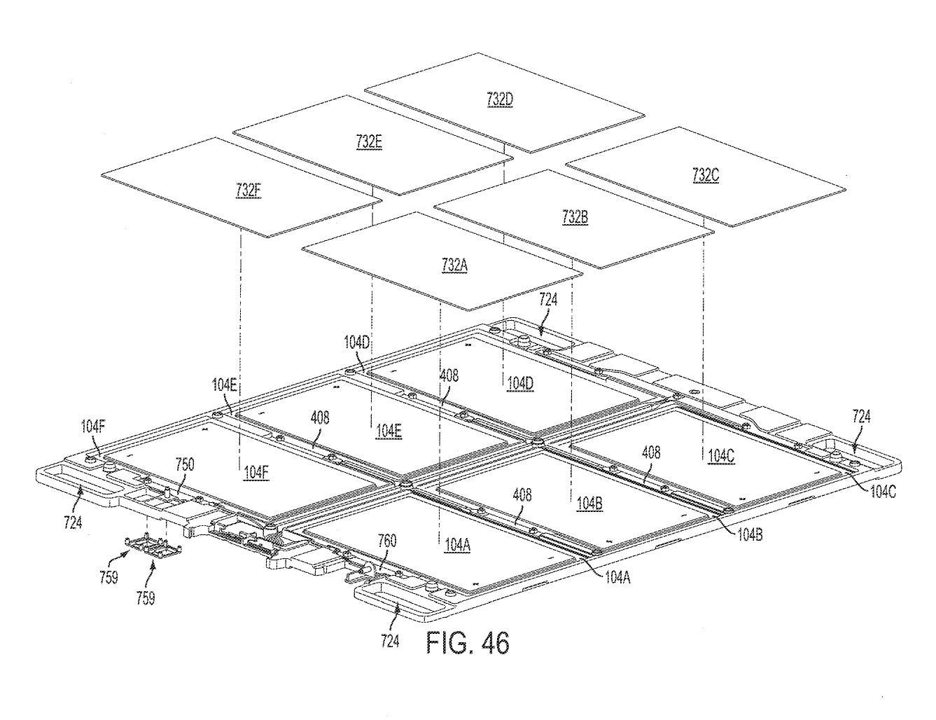

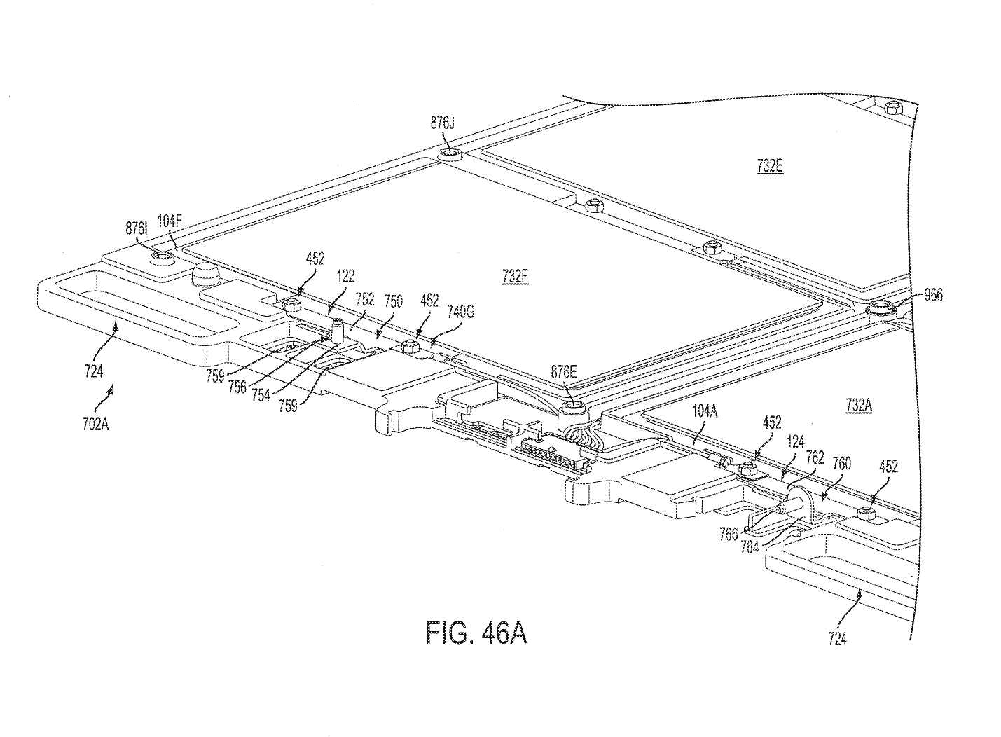

Further, referring to FIG. 31, as battery module 500 is being assembled, a foam member, such as foam member 732 in FIG. 46, is provided generally in region 550. The foam holds battery cells 104 in place. Various portions of support 402 contact the same regions on adjacent support 402. Examples include handles 470 (see FIG. 31), regions around the locator 540 (see FIG. 31), the central rib of support 402. These regions form a solid material stack in battery module 500 thereby increasing the rigidity of battery module 500. The use of the foam to hold cells 104, the nesting features, and the solid material stack permit battery module 500 to serve as its own shipping dunnage.

By having battery cells 104 spaced apart and using a thermoset material for support 402, the battery assembly 400 has improved thermal properties as discussed herein. An exemplary material for support 402 is DIELECTRITE E5V-204 SMC available from IDI Composites International located at 407 S. 7th Street in Noblesville, Ind. 46060. Additional details regarding DIELECTRITE E5V-204 SMC are provided in U.S. Provisional Patent Application Ser. No. 61/543,781, titled ENERGY STORAGE SYSTEM, filed Oct. 5, 2011, the disclosure of which is expressly incorporated by reference herein. Another exemplary material for support 402 is DIELECTRITE 46-16 BMC available from IDI Composites International located at 407 S. 7th Street in Noblesville, Ind. 46060. Additional details regarding DIELECTRITE 46-16 BMC are provided in U.S. Provisional Patent Application Ser. No. 61/543,781, titled ENERGY STORAGE SYSTEM, filed Oct. 5, 2011, the disclosure of which is expressly incorporated by reference herein.

Referring to FIG. 13A, a simulated thermal model of support 402 is shown. For the thermal model, the six cells 104 supported by support 402 are cycled at a 5 C rate for 7200 seconds. Each cell was modeled as a 9 Watt cell. The ambient temperature surrounding support 402 was modeled to be 30 degrees Celsius. At the conclusion of the modeling, the temperature difference across the pockets contacting the cells was about 4 degrees with a minimum temperature of 42 degrees C. and a maximum temperature of 46 degrees C. The modeling assumed no dynamic cooling either with a moving volume of air or other heat transfer fluid. The modeling assumed that the material of support 402 is a thermoset polyester material, IDI E-205 available from IDI Composites International located at 407 South 7th Street in Noblesville, Ind. 46060.

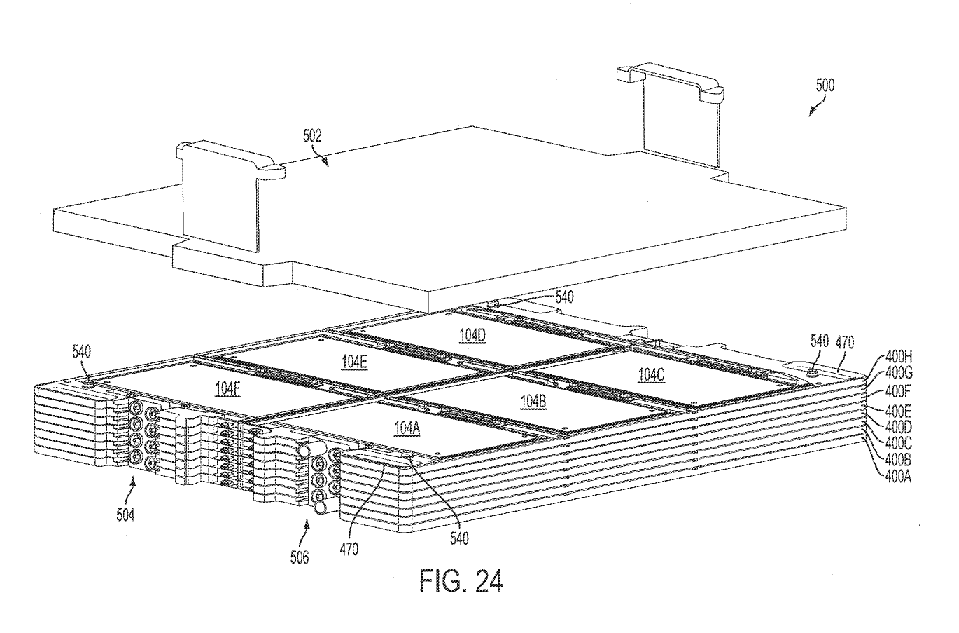

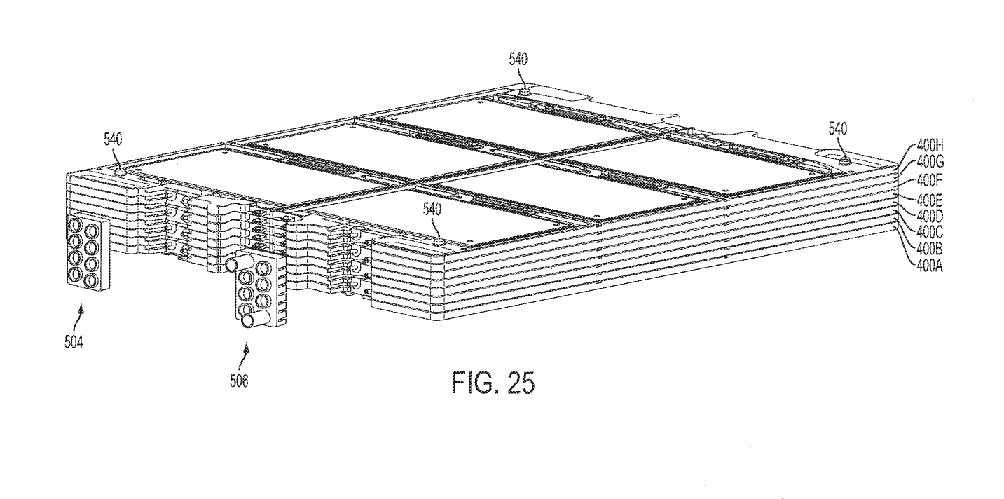

Although dynamic cooling is not required, air may be forced through battery module 500 to provide additional thermal management. Referring to FIG. 11, air is received through recesses in side 570 of battery assembly 400 (see FIGS. 24 and 25), travels through channels 572 (see FIG. 11) and exits recesses in side 574. The air is passed adjacent the terminals of the cells 104 to cool the cells 104. Further, compression bar 408 may include heat sink features, such as compression bar 408′ (see FIG. 13) In one embodiment, a first compression bar 408′ holds the terminals of cell 104A and cell 104B in contact while a second compression bar 408′ holds the terminals of cell 104F and cell 104G in contact. As such, the air flow shown in FIG. 11 would flow through a conduit which is formed through the cooperation of battery support 402, and the heat sink features of the two spaced-apart compression bars 408′.

Referring to FIGS. 13 and 13B, the plurality of heat sink features of compression bar 408′ are two upstanding fins 480 extending upward from a base portion 482. The space between the fins 480 define part of an air flow conduit 488. A longitudinal axis of the air flow conduit is parallel to a top face of cell 104A and a top face of cell 104B, as shown in FIG. 13. Further, the conduit 488 is spaced apart from the terminal of cell 104A and the terminal of cell 104B. Referring to FIG. 13C, another compression bar 408″ is shown. Compression bar 408″ includes three upstanding fins 480 extending upward from a base portion 482. The space between the two pairs of fins define part of two separate air flow conduits 488.

Battery module 500 may be placed in an enclosure 600 (see FIG. 39). Enclosures 600 may be mobile and include casters 602. Enclosure 600 further includes lifting jacks and fork lift points. The enclosure 600 may store multiple battery modules 500 as well as a high voltage module and a low voltage module. Exemplary high voltage and low voltage modules are disclosed in U.S. Provisional Patent Application Ser. No. 61/486,151 which is expressly incorporated by reference herein. Enclosure 600 may include buss bar connections along a top portion for connection to buss bars. Further, enclosure 600 may include a fire suppression port which may provide fire suppression fluid in case a fire or overheating is detected.

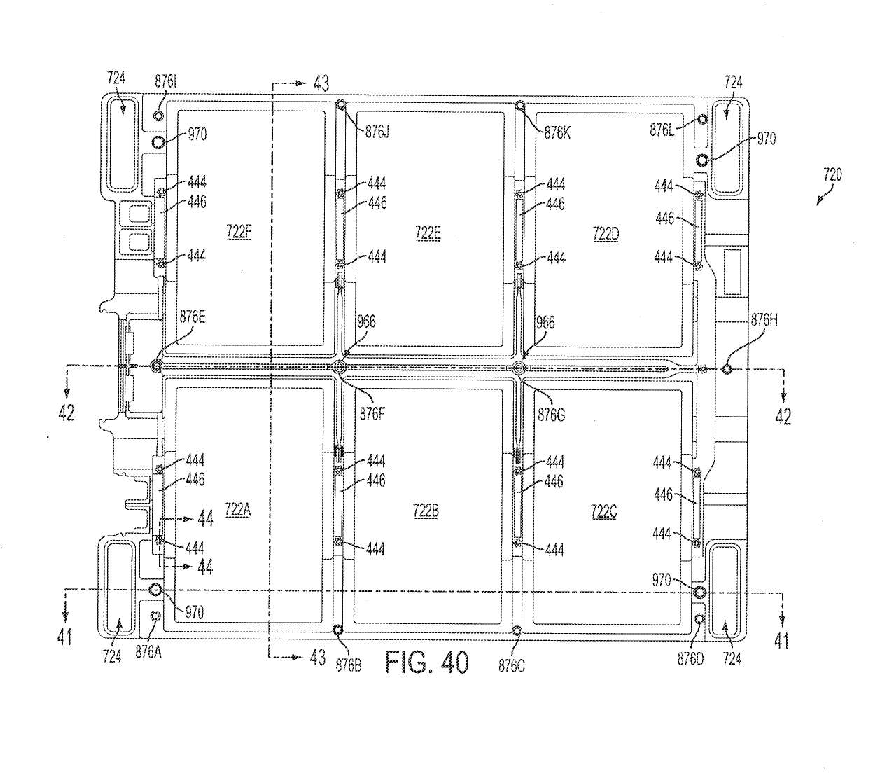

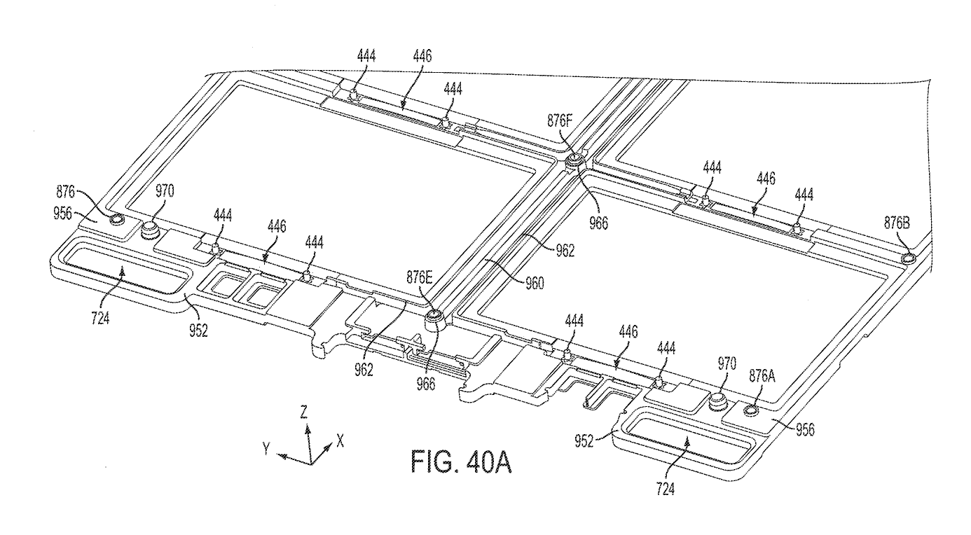

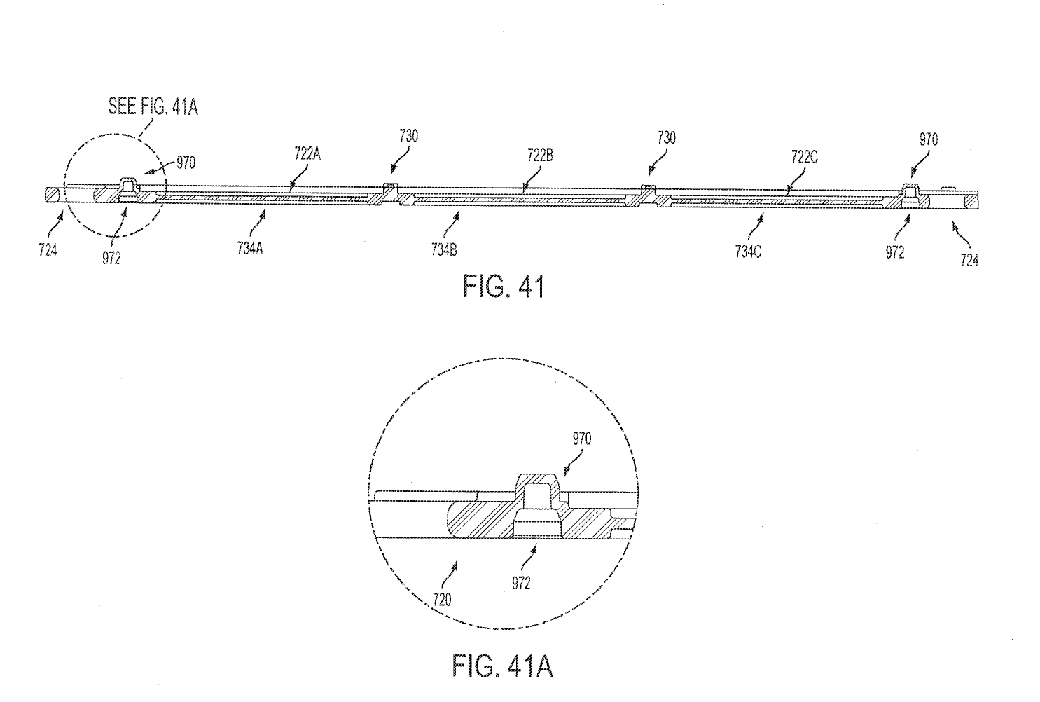

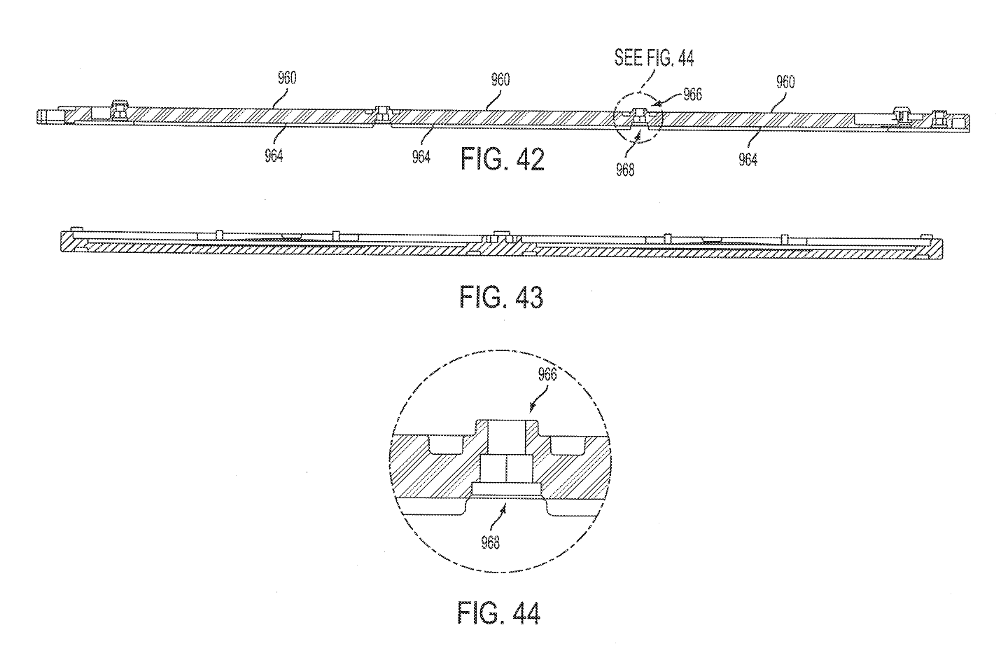

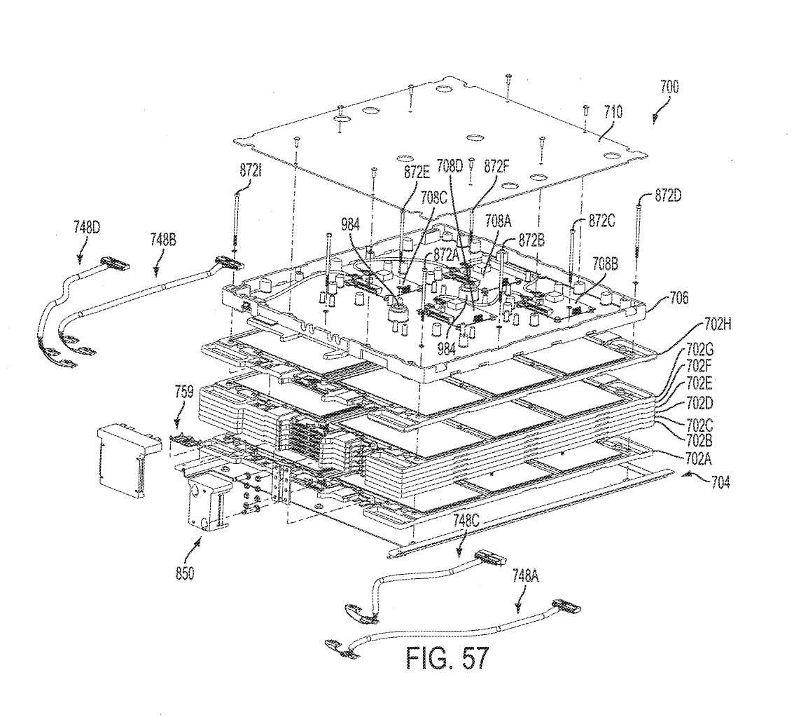

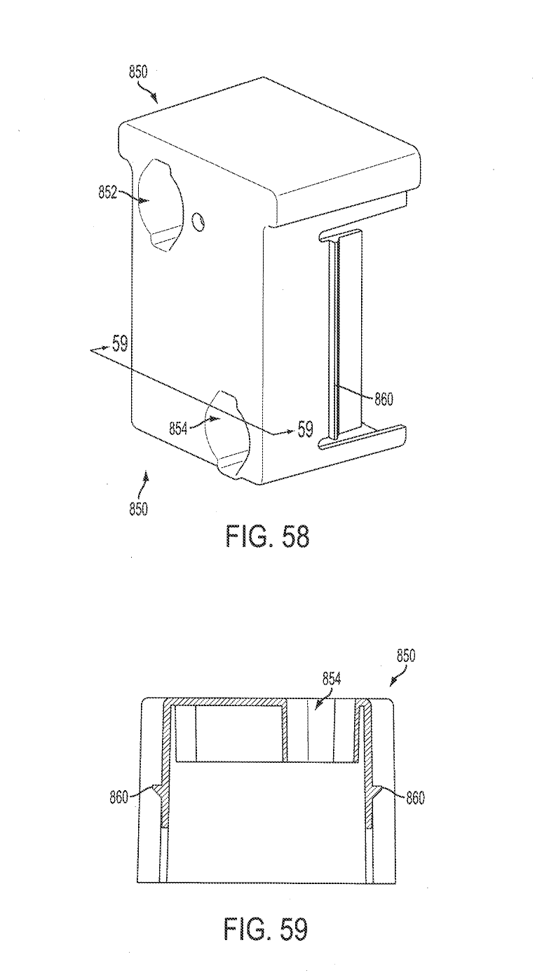

Referring to FIGS. 40-59, another exemplary battery assembly 700 (see FIG. 57) is shown. Referring to FIG. 57, battery assembly 700 includes a plurality of battery trays 702A-H, a battery management tray 706 housing a plurality of controllers 708A-D, and a cover 710. Battery tray 702A-H and battery management tray 706 are held together through a plurality of fasteners 872 (see FIG. 57). Fasteners 872, in one embodiment thread into nuts provided in recesses in a lower side of in battery tray 702A.

In one embodiment, a mounting member 704 which supports battery trays 702 for inclusion in a rack or other support, such as enclosure 600 in FIG. 39, is provided. Mounting member 704 includes a plurality of threaded fasteners 714 for receiving fasteners 872. Exemplary fasteners include bolts which are received in apertures of the trays 702 and tray 706 and PEM fasteners coupled to mounting member 704.

Referring to FIG. 40, a top view of a battery support 720 is shown. Battery support 720 is generally similar to support 402. Battery support 720 includes a plurality of pockets 722A-F. Pockets 722A-F receive corresponding cells 104A-F (see FIG. 46). The plurality of pockets 722 are separated by a plurality of walls 730.

Cells 104A-F are assembled to battery support 720 in the same manner as support 402. Battery support 720 like support 402 includes crowned regions 446 whereat the respective terminals 122, 124 of adjacent cells are overlapped. Further, battery support 720, like support 402, includes studs 444 which are overmolded by battery support 720. The cells are held in electrical contact by compression bar 408 (see FIG. 46) which are held relative to studs 444 with fasteners 452. The walls 730 of battery support 720 include openings in the portions corresponding to region 446 of battery trays 702 to permit the respective terminals 122, 124 of the cells 104 to come into contact.

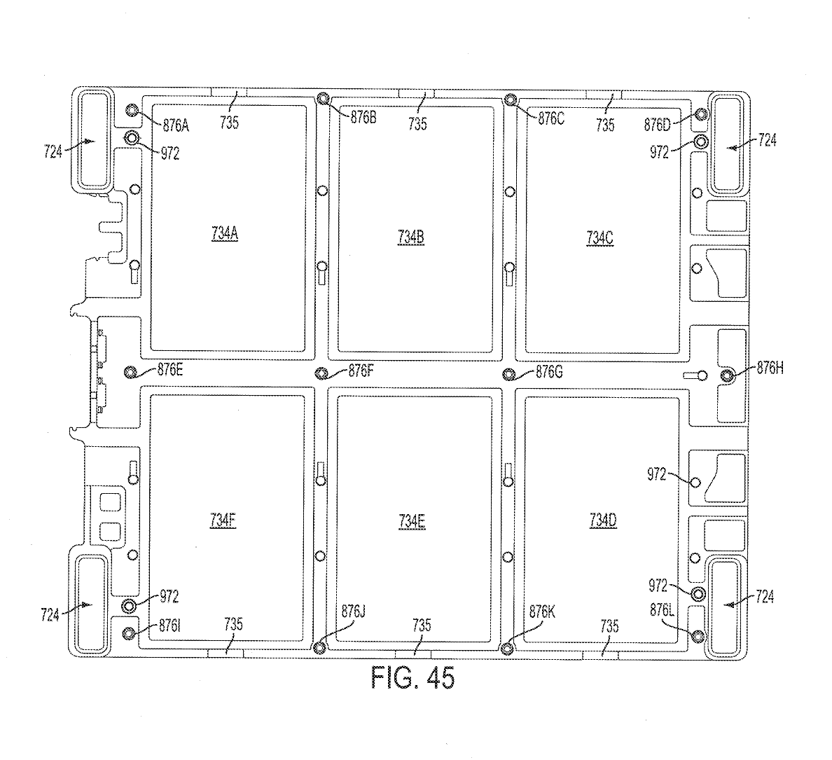

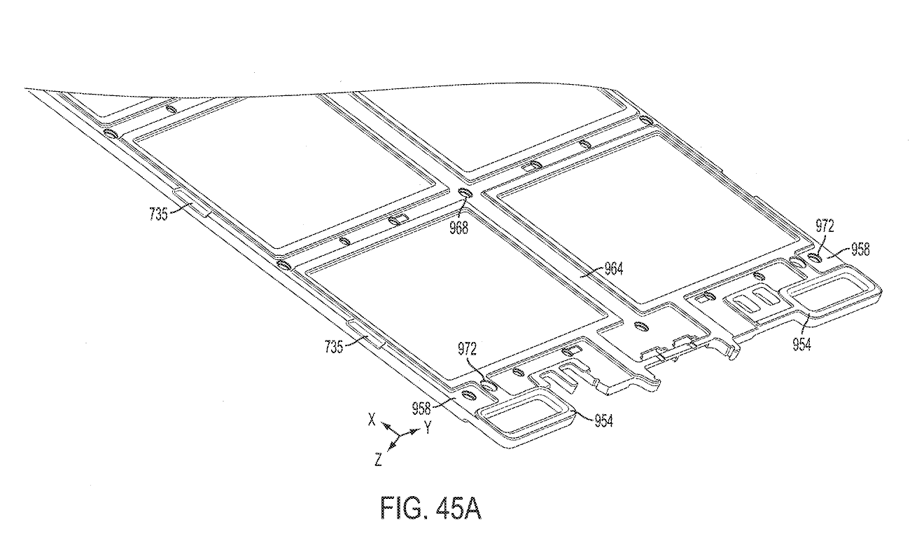

Referring to FIG. 46, compliant spacers 732 are positioned on top of battery cells 104. The compliant spacers 732 maintain battery cells 104 in the respective pockets 722 while permitting flexibility to allow the battery cells 104 to expand during cycling. The compliant spacers 732 are generally slightly larger than an active region of the cells 104 (generally the middle portion 126) such that the spacers may conform to follow the contour of the cell package about the active region and stabilize the contents of the cells during vibration. Exemplary compliant spacers are foam spacers. Referring to FIG. 45, a bottom side of battery support 720 includes pockets 734 to receive compliant spacers 732 when a second battery tray 702 is stacked on top of the first battery trays 702. A vent passage 735 is also provided in battery support 720 to couple the respective cell region (pocket 734) to an exterior of battery assembly 700.

In one embodiment, battery support 720 is made from a sheet moldable composite material. An exemplary sheet moldable composite material is DIELECTRITE E5V-204 SMC available from IDI Composites International located at 407 S. 7th Street in Noblesville, Ind. 46060. Additional details regarding DIELECTRITE E5V-204 SMC are provided in U.S. Provisional Patent Application Ser. No. 61/543,781, titled ENERGY STORAGE SYSTEM, filed Oct. 5, 2011, the disclosure of which is expressly incorporated by reference herein. Another exemplary material for support 102 is DIELECTRITE 46-16 BMC available from IDI Composites International located at 407 S. 7th Street in Noblesville, Ind. 46060. Additional details regarding DIELECTRITE 46-16 BMC are provided in U.S. Provisional Patent Application Ser. No. 61/543,781, titled ENERGY STORAGE SYSTEM, filed Oct. 5, 2011, the disclosure of which is expressly incorporated by reference herein.

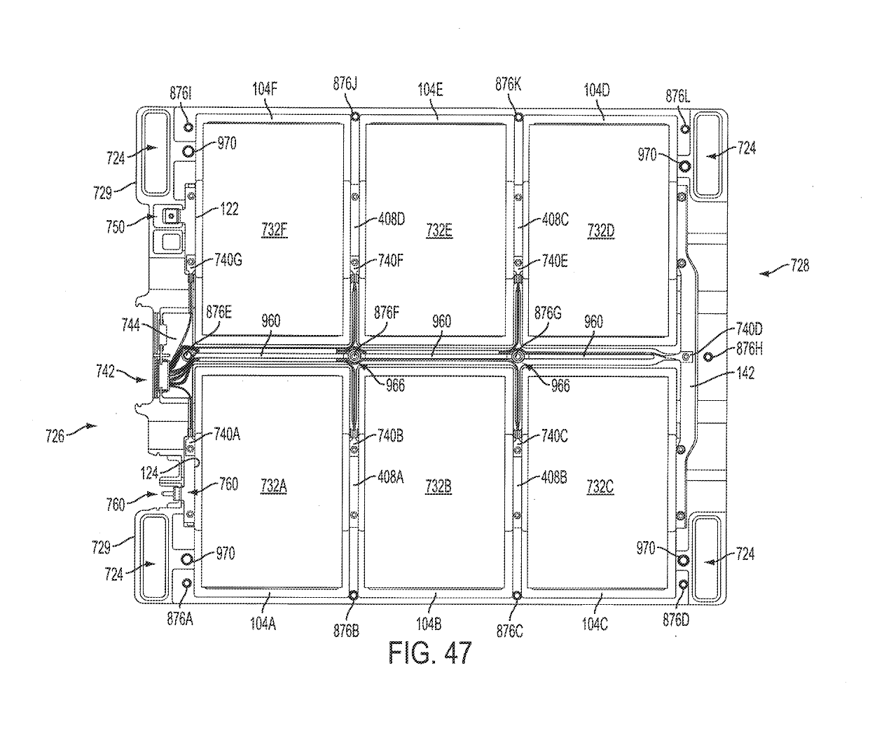

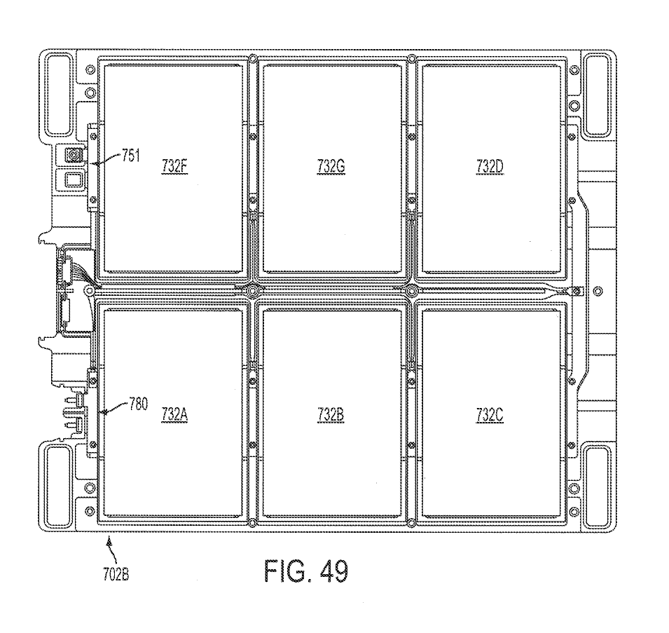

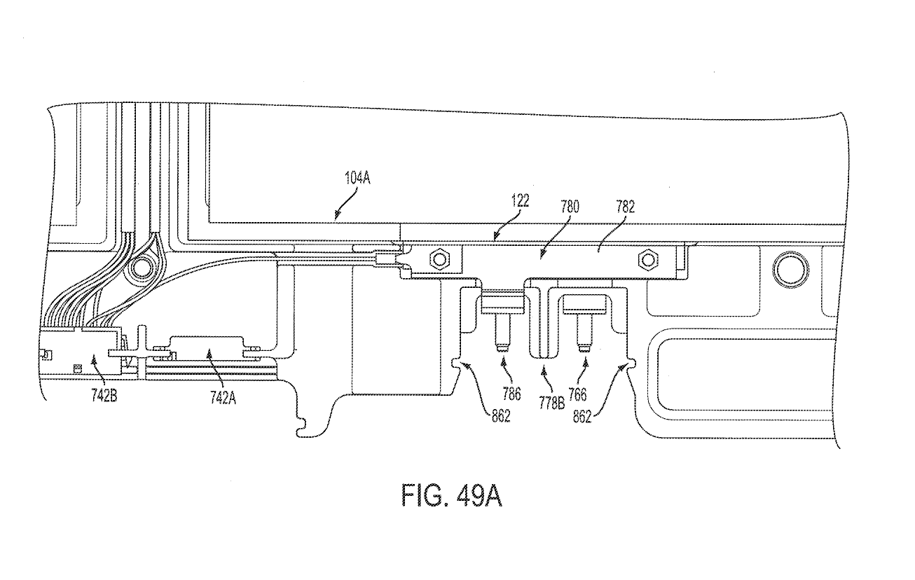

Returning to FIG. 47, voltage sense connections 740A-G are provided at the positive terminal of cell 104A, at the electrical connection between adjacent cells 104A-F, and at the negative terminal 122 of cell 104F. Each of the voltage sense connections is coupled to a first connector 742 through a respective wire of a wiring harness 744. The first connector 742 is coupled to the battery support 720. Battery support 720 further supports two thermistors (not shown) which are generally proximate to two of compression bar 408A-D. The thermistors are also coupled to first connector 742 through respective wires of wiring harness 744. Battery trays 702 have both the voltage sense connections and the temperature connections accessible from the same side of battery trays 702. Referring to FIG. 49, a second tray 702B is shown. The second tray 702B is stacked on top of tray 702A. Battery tray 702B includes one less of voltage sense connection 740A-F. This is because a terminal bar 750 (see FIG. 46A) of battery tray 702A is coupled to a terminal bar 751 (see FIG. 49) of battery tray 702B and are therefore at the same voltage.

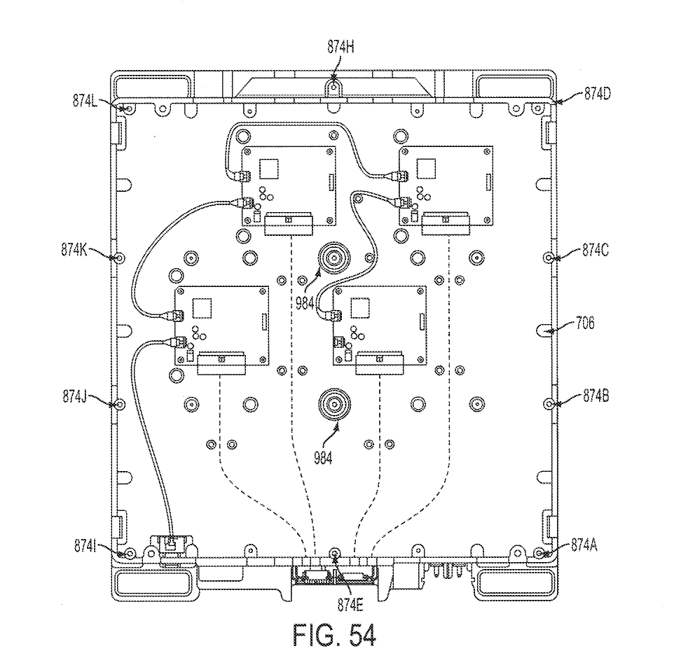

Returning to FIG. 57, the first connector 742 of battery tray 702A and the first connector 742 of battery tray 702B are coupled to controller 708A through a first wire harness 748A. In a like manner, the first connector 742 of battery tray 702C and the first connector 742 of battery tray 702D are coupled to controller 708B through a wire harness 748B, the first connector 742 of battery tray 702E and the first connector 742 of battery tray 702F are coupled to controller 708C through a wire harness 748C, and the first connector 742 of battery tray 702G and the first connector 742 of battery tray 702H are coupled to controller 708D through a wire harness 748D. Referring to FIG. 54, the routing of the wire harnesses 748A-D to controllers 708A-D is shown. As illustrated in FIG. 54, battery management tray 706 includes a plurality of protrusions which route the wire harness 748A-D.

Returning to FIG. 46A the assembly of battery assembly 700 is discussed. As shown in FIG. 46A, battery tray 702A includes a terminal bar 750 coupled to the terminal of cells 104F. Terminal bar 750 includes a first portion 752 overlapping the terminal 122 of cell 104F and a second raised portion 754. The second raised portion 754 supports a threaded stud 756. A pair of caps 759 are assembled to battery tray 702A to prevent access to terminal bar 750 from a bottom side of battery tray 702A.

Similarly a terminal jumper 760 is coupled to the terminal of cell 104A. Terminal jumper 760 includes a first portion 762 overlapping the terminal 124 of cell 104A and a second upward extending portion 764. The second upward extending portion 764 supports a threaded stud 766.

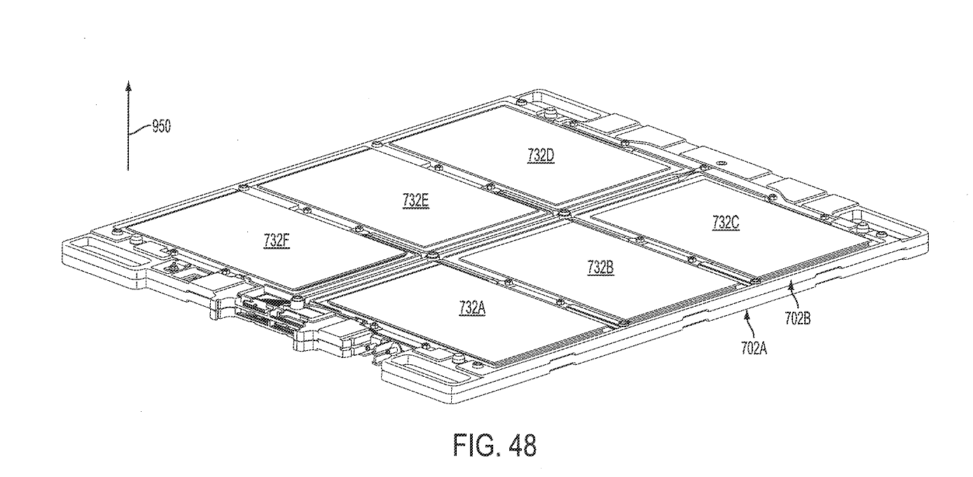

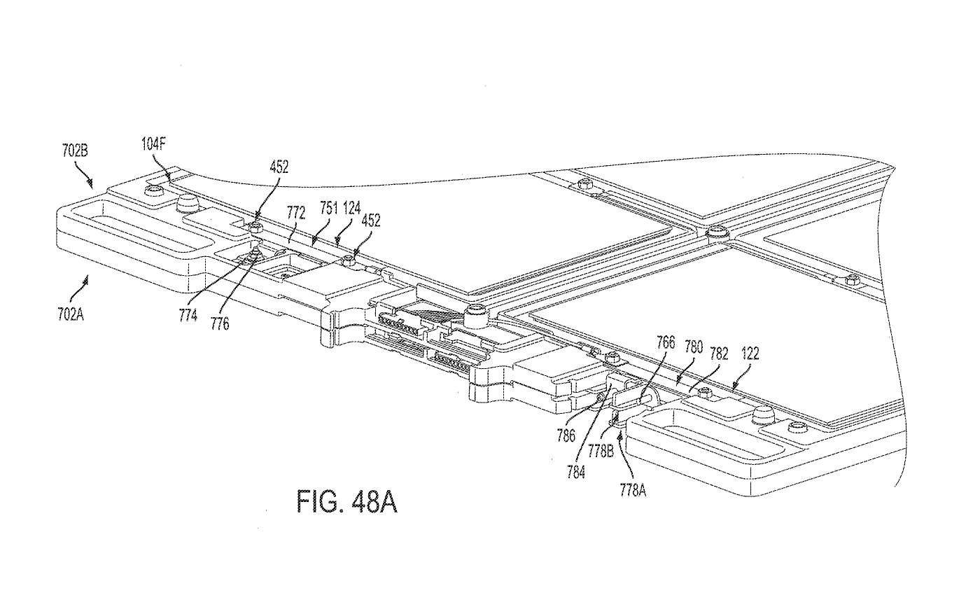

Referring to FIG. 48A, a second tray 702B is stacked on top of first tray 702A. The second tray 702B includes a terminal jumper 751 coupled to the terminal of cell 104F of second tray 702B. Terminal bar 751 includes a first portion 772 overlapping the terminal 124 of cells 104F of battery tray 702B and a second lowered portion 774. The second lowered portion 774 includes an aperture to receive the threaded stud 756 of terminal bar 750. Terminal bar 751 is coupled to terminal bar 750 with a fastener 776. The connection between terminal bar 750 and terminal bar 751 results in the negative terminal 122 of cell 104F of battery tray 702A being electrically connected to positive terminal 124 of cell 104F of battery tray 702B and hence the battery cells 104 of battery tray 702A being electrically coupled in series with the battery cells 104 of battery tray 702B. By rearranging the orientation of the battery cells 104 of battery tray 702B, the negative terminal 122 of cells 104F of battery tray 702B may be overlapped by terminal bar 751 resulting in the battery cells 104 of battery tray 702A being electrically connected to the battery cells 104 of battery tray 702B in parallel.

Similarly a terminal jumper 780 is coupled to the terminal 122 of cell 104A of battery tray 702B. Terminal jumper 780 includes a first portion 782 overlapping the terminal 122 of cell 104A and a second downward extending portion 784. The second downward extending portion 784 supports a threaded stud 786. Battery tray 702A and battery tray 702B form a battery assembly having twelve battery cells 104 in series with threaded stud 786 being a negative terminal of the assembly and threaded stud 766 being a positive terminal of the assembly. Both battery support 720A and battery support 720B include a blocking member 778 which separates threaded stud 786 from threaded stud 766 to prevent accidental contact between threaded stud 786 and threaded stud 766 (see FIG. 49A).

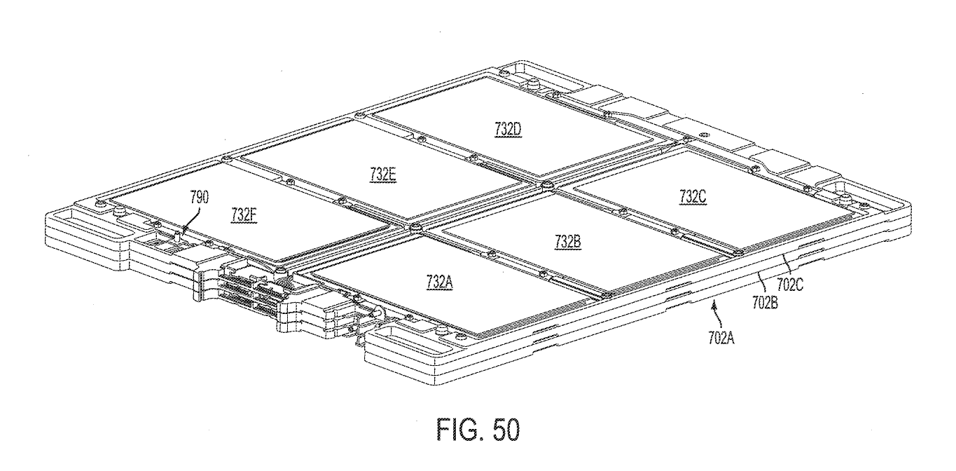

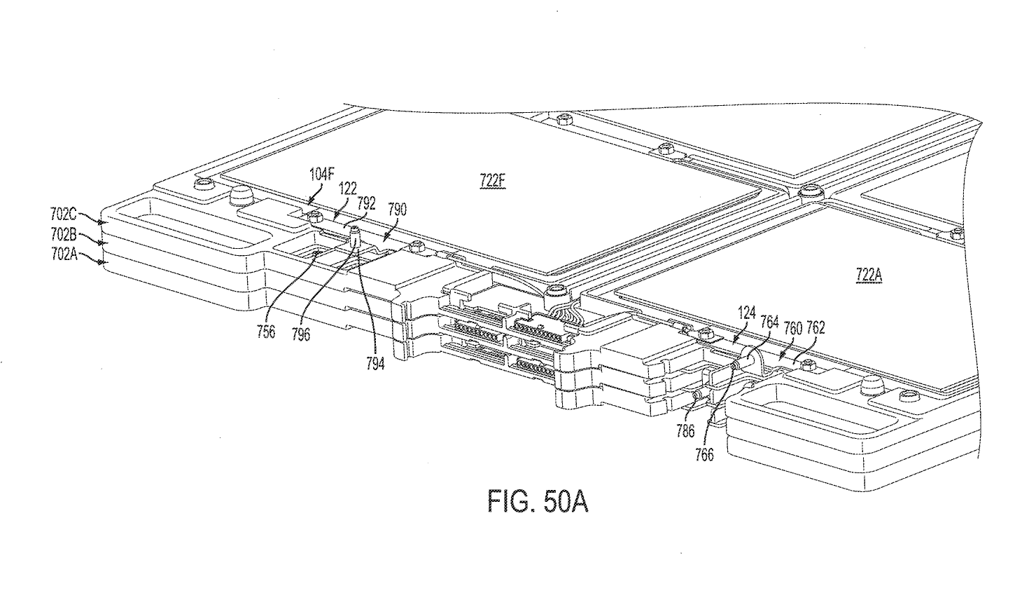

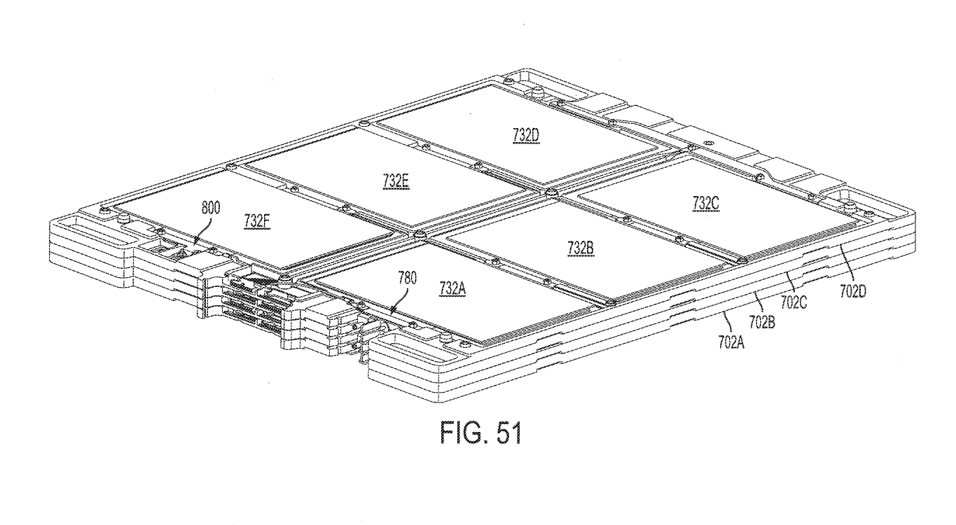

As shown in FIG. 50A, a third tray 702C is supported on top of battery tray 702B. Battery tray 702C includes a terminal jumper 790 coupled to the terminal 122 of cells 104F of battery tray 702C. Terminal jumper 790 includes a first portion 792 overlapping the terminal 122 of cells 104F and a second raised portion 794. The second raised portion 794 supports a threaded stud 796. As shown in FIG. 50A, threaded stud 796 is not positioned directly over threaded stud 756. This provides additional clearance between threaded stud 796 and threaded stud 756.

Similarly a terminal jumper 760 is coupled to the terminal 124 of cell 104A of battery tray 702C. Terminal jumper 760 includes a first portion 762 overlapping the terminal 124 of cell 104A of battery tray 702C and a second upward extending portion 764. The second upward extending portion 764 supports a threaded stud 766.

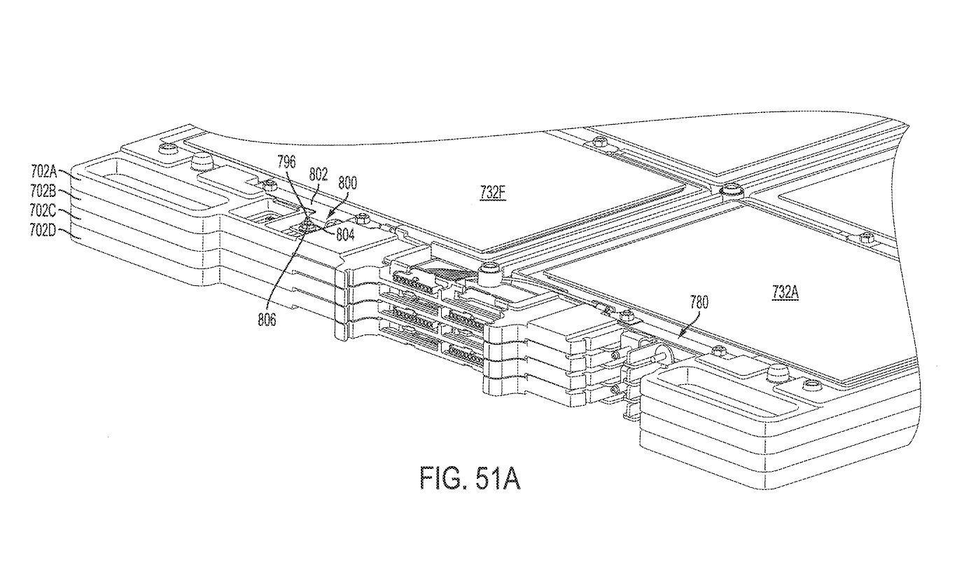

Referring to FIG. 51A, a fourth tray 702D is stacked on top of third tray 702C. The fourth tray 702D includes a terminal jumper 800 coupled to the terminal of cells 104F of fourth tray 702D. Terminal jumper 800 includes a first portion 802 overlapping the terminal 124 of cells 104F of battery tray 702B and a second lowered portion 804. The second lowered portion 804 includes an aperture to receive the threaded stud 796 of terminal jumper 790. Terminal jumper 800 is coupled to terminal jumper 790 with a fastener 806. The connection between terminal jumper 790 and terminal jumper 800 results in the negative terminal 122 of cell 104F of battery tray 702C being electrically connected to positive terminal 124 of cell 104F of battery tray 702D and hence the battery cells 104 of battery tray 702C being electrically coupled in series with the battery cells 104 of battery tray 702D. By rearranging the orientation of the battery cells 104 of battery tray 702D, the negative terminal 122 of cells 104F of battery tray 702D may be overlapped by terminal jumper 800 resulting in the battery cells 104 of battery tray 702C being electrically connected to the battery cells 104 of battery tray 702D in parallel.

Similarly a terminal jumper 780 is coupled to the terminal 122 of cell 104A of battery tray 702D. Terminal jumper 780 includes a first portion 782 overlapping the terminal 122 of cell 104A and a second downward extending portion 784. The second downward extending portion 784 supports a threaded stud 786. Battery tray 702C and battery tray 702D form a battery assembly having twelve battery cells 104 in series with threaded stud 786 being a negative terminal of the assembly and threaded stud 766 being a positive terminal of the assembly. Both battery support 720C and battery support 720D include a blocking member 778 which separates threaded stud 786 from threaded stud 766 to prevent accidental contact between threaded stud 786 and threaded stud 766.

Trays 702E-H are interconnected in the same manner as trays 702A-D. Tray 702E corresponds to tray702A and is interconnected with tray 702F in the same manner that tray 702B is interconnected with tray 702A. In a similar fashion, tray 702G corresponds to tray 702C and is interconnected with tray 702H in the same manner that tray 702D is interconnected with tray 702C.

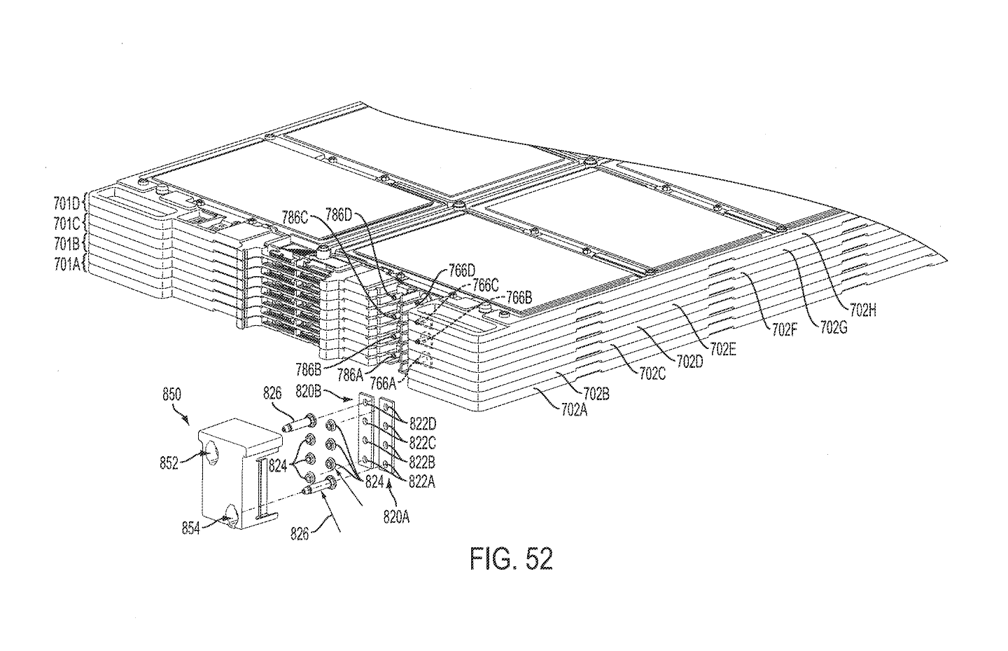

Referring to FIG. 52, the stack of trays 702A-H is shown. Trays 702A, 702C, 702E, and 702G include threaded studs 766A-D, respectively. Threaded studs 766A-D correspond to the positive terminals of the respective battery assemblies 701A-D (stud 766A corresponds to the assembly 701A of tray 702A and tray 702B, stud 766B corresponds to the assembly 701B of tray 702C and tray 702D, stud 766C corresponds to the assembly 701C of tray 702E and tray 702F, and stud 766D corresponds to the assembly 701D of tray 702G and tray 702H). Trays 702B, 702D, 702F, and 702H include threaded studs 786A-D, respectively. Threaded studs 786A-D correspond to the negative terminals of the respective battery assemblies 701A-D (stud 786A corresponds to the assembly 701A of tray 702A and tray 702B, stud 786B corresponds to the assembly 701B of tray 702C and tray 702D, stud 786C corresponds to the assembly 701C of tray 702E and tray 702F, and stud 786D corresponds to the assembly 701D of tray 702G and tray 702H).

The battery assemblies 701A-D are electrically coupled together in parallel with electrical connectors 820A, 820B. Electrical connector 820A couples threaded studs 766A-D together in parallel. Electrical connector 820A includes a plurality of apertures 822A-D which receive respective threaded studs 766A-D. Threaded studs 766B-D are secured relative to electrical connector 820A with threaded fasteners 824. Threaded stud 766A is secured relative to electrical connectors 820A with a threaded fastener 826. In a similar manner, electrical connector 820B couples threaded studs 786A-D together in parallel. Electrical connector 820B includes a plurality of apertures 822A-D which receive respective threaded studs 786A-D. Threaded studs 786A-C are secured relative to electrical connectors 820B with threaded fasteners 824. Threaded stud 786D is secured relative to electrical connectors 820B with a threaded fastener 826.

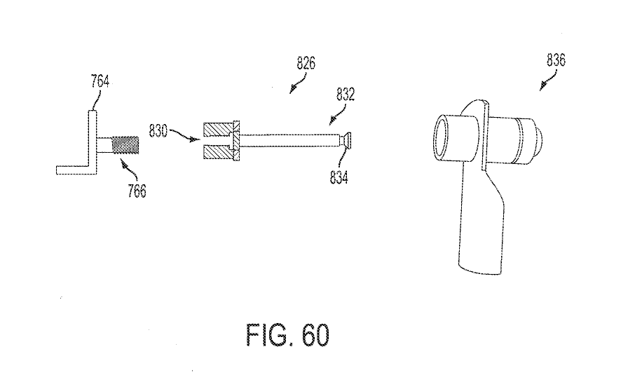

Referring to FIG. 60, threaded fastener 826 includes an internal threaded portion 830 which threadably engages with threaded stud 766 (illustrated) or threaded stud 786. A second portion 832 of threaded fastener 826 includes a recess 834 which interacts with a terminal connector 836. In one embodiment, terminal connector 836 is a RADSOK brand terminal connector available from Amphenol located at 358 Hall Avenue in Wallingford, Conn. 06492.

Returning to FIG. 52, threaded stud 766 and threaded stud 786 are covered with an electrical cover 850. Electrical cover 850 includes a first opening 852 to permit a terminal connector 836 to be coupled to the threaded fastener 826 coupled to threaded stud 786D and a second opening 854 to permit a terminal connector 836 to be coupled to the threaded fastener 826 coupled to threaded stud 766A. Referring to FIG. 59, electrical cover 850 includes portions 860 which are received in recesses 862 of battery trays 702 (see FIG. 46A) to couple electrical cover 850 to the stack of battery trays 702.

In the stack of battery trays 702 illustrated in FIG. 52, the battery assemblies 701 are electrically connected together in parallel. This configuration results in four parallel groups (two trays each) of batteries with each group including twelve cells in series. Assuming the voltage of cells 104 is nominally 4 volts, the illustrated configuration results in a 48 volt system. By adjusting one or more of the battery orientations on respective trays 702, the terminal jumper configurations, and the connectors 820, it is possible to produce other configurations. Another exemplary configuration includes a single group (eight trays) wherein each tray is coupled together in series and the cells of each tray are connected in series. This results in forty-eight cells being coupled together in series. Assuming the voltage of the cells 104 is nominally 4 volts, this configuration results in a 192 volt system. Yet another exemplary configuration includes two parallel groups (four trays each) of batteries with each group including twenty-four cells in series. Assuming the voltage of the cells 104 is nominally 4 volts, this configuration results in a 96 volt system. A further exemplary configuration includes eight parallel groups (one tray each) of batteries with each group including six cells in series. Assuming the voltage of the cells 104 is nominally 4 volts, this configuration results in a 24 volt system.

Although a stack of eight trays 702 is shown, more or less trays may be included in the stack based on the application. Further, multiple stacks of trays may be coupled together in a variety of configurations to produce larger battery assemblies or strings. Although each tray 702 is shown to include six cells 104, the number of cells 104 in a tray may be more or less. Further, although the internal electrical connections of the individual trays 702 have the respective cells 104 coupled together in series, the cells 104 may form one or more parallel groups.

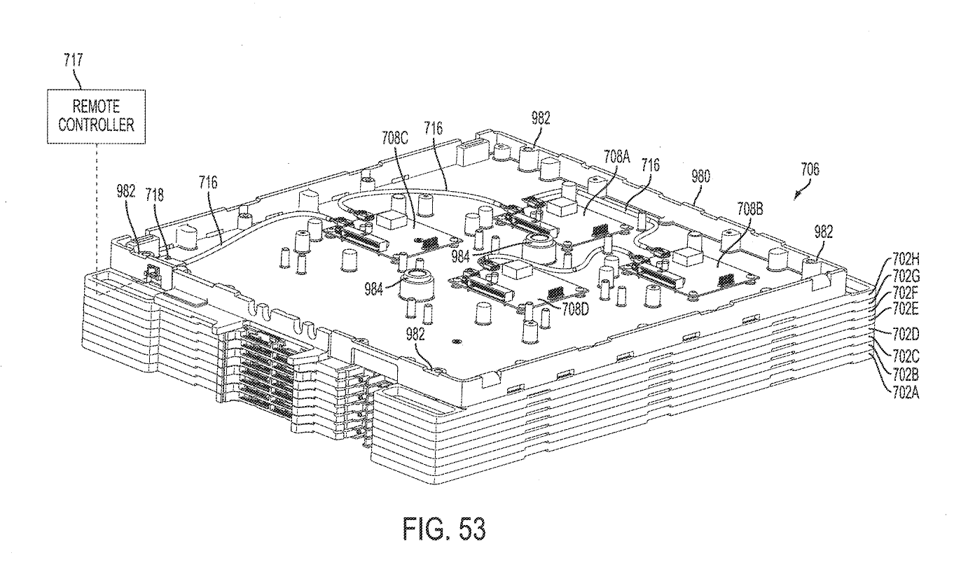

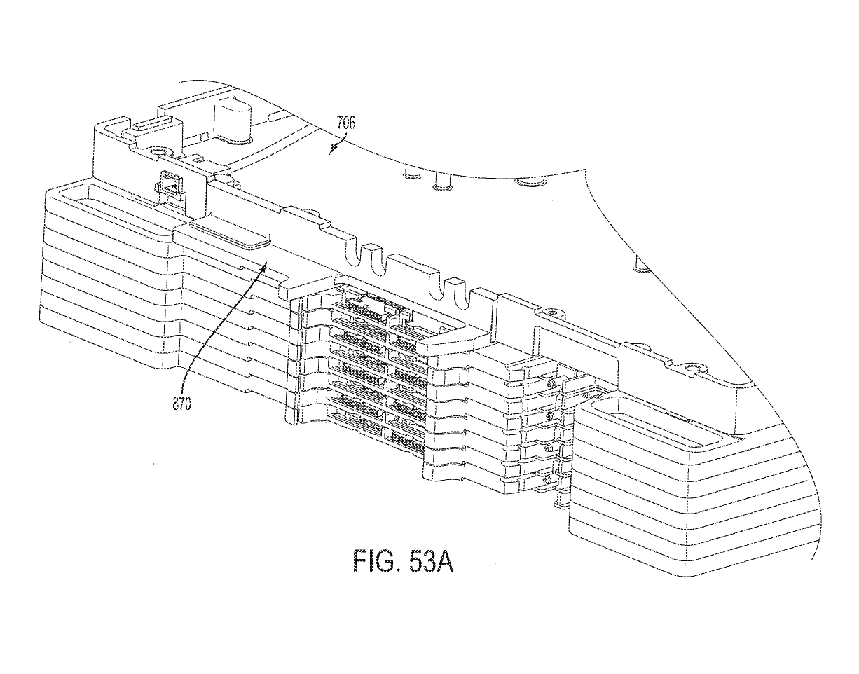

Referring to FIG. 53, battery management tray 706 is stacked on top of the plurality of trays 702. Battery management tray 706 houses controllers 708A-D. Controllers 708A-D are coupled to battery management tray 706 with fasteners. Controllers 708A-D are stringed together with data wire harnesses 716 which are coupled to a connector 718 accessible from an exterior of battery management tray 706. Battery management tray 706 includes features to route the data wire harnesses 716. Connector 718 may receive a wire harness to couple controllers 708A-D to a remote controller 717 which monitors and controls the battery assembly. Exemplary remote controllers are disclosed in PCT Application No. PCT/US11/52169, filed Sep. 19, 2011, titled ENERGY STORAGE SYSTEM, the disclosure of which is expressly incorporated by reference herein. In one embodiment, controllers 708A-D communicate with remote controller 717 over a wireless connection.

Referring to FIG. 57, battery management tray 706 includes a cover portion 870 which prevents access to the terminal jumpers 750, 751, 792, 800 of the trays 702A-H. Battery management tray 706 and battery tray 702A-H are held together with tie rods 872A-L. Tie rods 872A-L are received by apertures 874A-L (see FIG. 54) in battery management tray 706 and apertures 876A-L (see FIG. 40) in trays 702A-H. In one embodiment, tie rods 872A-L are threaded into fasteners carried by battery tray 702A. In the illustrated embodiment, tie rods 872A-L are threaded into fasteners 876A-L carried by mounting member 704 (see FIG. 55). Mounting member 704 supports battery tray 702A-H and battery management tray 706. A top of battery management tray 706 is covered by cover 710 and secured with fasteners.

In one embodiment, the battery management tray and the plurality of trays 702 are banded together with bands (not shown). Referring to FIG. 53A, battery management tray 706 includes portions 707 to receive and capture an band when tightened about the battery management tray 706 and trays 702.

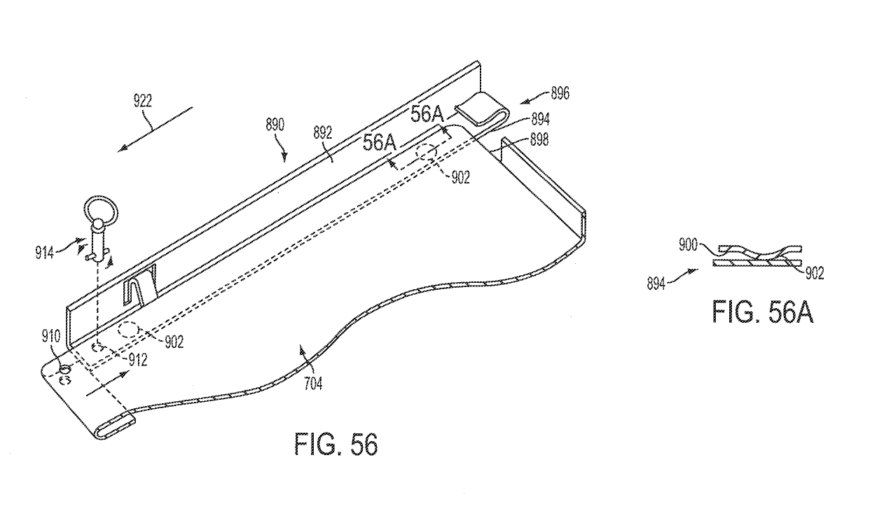

Referring to FIG. 56, mounting member 704 cooperates with a first rail 890 of enclosure 600 to support battery assembly 700 within enclosure 600. A second rail 890 is provided on the opposite side of mounting member 704. Rail 890 includes a first portion 892 which is coupled to the frame of enclosure 600 and a second portion 894 which supports battery assembly 700. A rear portion 896 of second portion 894 includes a clip 902 which receives a rear surface 898 of mounting member 704 when battery assembly 700 is fully seated in enclosure 600. In the illustrated embodiment, a lower surface 900 of mounting member 704 includes dimples 902 to assist in sliding mounting member 704 relative to rail 890. Further, mounting member 704 includes an aperture 910 which aligns with an aperture 912 of rail 890 when mounting member 704 is fully seated. A pin or other fastener 914 is received in aperture 910 and aperture 912 to secure mounting member 704 relative to rail 890.

A feature 920 extends inward from first portion 892 above mounting member 704. Feature 920 may be a portion of first portion 892 bent inward or a member attached to rail 890. Feature 920 serves to reduce tipping of mounting member 704 as mounting member 704 is moved in direction 922.

Referring to FIG. 47, the battery support 720 of battery tray 702 includes a plurality of handles 724. Handles 724 define the envelope of battery tray 702 on a first end 726 and a second end 728. The connectors 742 provided on the first end 726 are inset from the leading edge 729 of first side 726 provided by handles 724. In addition, terminal bars 750 and 760 are inset from the leading edge 729 of first side 726 provided by handles 724. As shown in FIG. 53, when a plurality of battery trays 702 are stacked together, the handles 724 of each battery trays 702 are generally aligned. Since handles 724 define the envelope of battery assembly 400 along first end 726 and second end 728, a battery assembly 700 may be stood on end on first side 726 without stressing connectors 742 or terminal bars 750 and 760.

In the illustrated embodiment, each handle 724 includes an aperture extending from a top side of the tray 702 through to a bottom side of the tray 702. When multiple trays 702 are stacked together the apertures of the respective handles 724 are generally aligned.

Referring to FIG. 48, a second tray 702B is shown supported by a first tray 702A. Each of trays 702A and 702B include cooperating features which provide a solid stack in direction 950. The solid stack extends from a top side of the second battery support 720B of the second tray 702B through to a bottom side of the first battery support 720A of the first tray 702A. The solid stack is provided in regions of the first tray 702A spaced apart from the first plurality of prismatic battery cells 104. In the illustrated embodiment, the solid stack is provided in a first region about a perimeter of the battery support 720A of the first tray 702A and about a perimeter of the battery support 720B of the second tray 702B and in a second region extending between a first group and a second group of the first plurality of prismatic battery cells 104 of the first tray 702A and extending between a third group and a fourth group of the second plurality of prismatic battery cells 104 of the second tray 702B.

Referring to FIG. 40A, an exemplary portion 952 of the first battery support 720A bounding each handle 724 and the corresponding mating exemplary portion 954 (see FIG. 45A) of the second battery support 720B are part of the first region of the solid stack. In addition, exemplary portion 956 of the first battery support 720A extending along the sides of first battery support 720A and the corresponding mating exemplary portion 958 (see FIG. 45A) of the second battery support 720B are part of the first region of the solid stack. Exemplary portions 960 and 962 of the first battery support 720A extending along the longitudinal center of first battery support 720A and the corresponding mating exemplary portion 964 (see FIG. 45A) of the second battery support 720B are part of the second region of the solid stack. Exemplary portions 966 of the first battery support 720A provided along the longitudinal center of first battery support 720A and the corresponding mating exemplary portion 968 (see FIG. 45A) of the second battery support 720B are part of the second region of the solid stack. Although a few exemplary mating portions have been identified that provide a solid stack between battery support 720A and 720B, additional mating portions may be included.

Portions 966 of first support 720A include apertures 876 which permit battery management tray 706 and battery tray 702A-H to be held together with tie rods 872A-L (see FIG. 57). In addition, battery supports 720 include locating features 970 (FIG. 40A) and 972 (FIG. 45A) which assist in the alignment of the respective battery trays 702 when stacked. In the illustrated embodiment, the bottom side of battery management tray 706 includes the same portions which provide the solid stack within the stacked plurality of trays 702 and the locating features 972. Referring to FIG. 53, battery management tray includes a perimeter portion 980 and bosses 982 and 984 which carry the solid stack of the stacked plurality of trays 702 to the top of the battery management tray 706, thereby providing a solid stack from a bottom side of tray 702A through to a top side of battery management tray 706 in both the first region and the second region. Although the solid stack is illustrated as being comprised of only the plurality of trays 702 and the battery management tray 706, in one embodiment, additional members are provided between either two of the battery trays 702 or between battery tray 702H and battery management tray 706 which contribute to the solid stack.

The battery arrangements disclosed herein may be coupled together to form battery strings. The processing sequences disclosed in U.S. Provisional Patent Application Ser. No. 61/486,151 and PCT Application No. PCT/US11/52169, filed Sep. 19, 2011, titled ENERGY STORAGE SYSTEM may be used to monitor and control the operation of the battery arrangements disclosed herein. The trays disclosed herein may replace the drawers in the illustrated embodiment disclosed in U.S. Provisional Patent Application Ser. No. 61/486,151 and PCT Application No. PCT/US11/52169, filed Sep. 19, 2011, titled ENERGY STORAGE SYSTEM to provide the battery power of the energy modules disclosed in U.S. Provisional Patent Application Ser. No. 61/486,151 and PCT Application No. PCT/US11/52169, filed Sep. 19, 2011, titled ENERGY STORAGE SYSTEM. The disclosure of U.S. Provisional Patent Application Ser. No. 61/486,151 and PCT Application No. PCT/US11/52169, filed Sep. 19, 2011, titled ENERGY STORAGE SYSTEM are expressly incorporated by reference herein.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A battery system, comprising:
a plurality of prismatic battery cells including a first cell having a first terminal extending from the first cell and a second cell having a second terminal extending from the second cell;
a support locating the plurality of prismatic cells such that the first terminal of the first cell overlaps the second terminal of the second cell; and
a compression member removably coupled to the support, the compression member holding the first terminal of the first cell in contact with the second terminal of the second cell, the compression member including a plurality of heat sink features.

2. The battery assembly of claim 1, wherein the compression member includes a plurality of heat transfer fins along an upper side.

3. The battery system of claim 1, wherein the compression member includes a base portion which holds the first terminal of the first cell in contact with the second terminal of the second cell and the plurality of heat sink features include a plurality of fins extending from the base portion on a side opposite of the first cell and the second cell.

4. The battery system of claim 3, wherein the plurality of fins define a conduit therebetween that receives a flow of air to cool the first and second cells.

5. The battery system of claim 4, wherein the conduit has a longitudinal axis which is parallel to a top face of the first cell and a top face of the second cell.

6. The battery system of claim 4, wherein the conduit is further defined by the support.

7. The battery system of claim 1, wherein the compression member includes a base portion which holds the first terminal of the first cell in contact with the second terminal of the second cell and the plurality of heat sink features include a plurality of fins extending from the base portion, the plurality of fins defining a conduit therebetween that receives air to cool the first and second cells, wherein the conduit has a longitudinal axis which is parallel to a top face of the first cell and a top face of the second cell.

8. The battery system of claim 7, wherein the conduit is spaced apart from the first terminal of the first cell and the second terminal of the second cell.

9. The battery assembly of claim 1, wherein the support includes a plurality of overmolded studs positioned proximate the first cell and the second cell and wherein the compression member includes a plurality of apertures to receive the plurality of overmolded studs, the compression member being secured to the plurality of overmolded studs through a plurality of fasteners.

10. The battery system of claim 1, wherein the support is a tray which supports the first cell and the second cell in a side-by-side arrangement, the battery support extending under a middle portion of each of the first cell and the second cell.

11. The battery system of claim 1, wherein the support surrounds a perimeter of the first cell.

12. The battery system of claim 11, wherein the support surrounds a perimeter of the second cell.

13. The battery system of claim 1, wherein the support surrounds the compression member.

14. The battery system of claim 1, wherein the plurality of prismatic cells are electrically coupled together and are electrically coupled to a positive terminal supported by the support and a negative terminal supported by the support.

15. The battery system of claim 14, wherein the positive terminal and the negative terminal are positioned along a first side of the support and the compression member is spaced apart from the first side of the support.

16. The battery system of claim 14, wherein the plurality of prismatic battery cells further includes a third cell having a third terminal extending from the third cell and a fourth cell having a fourth terminal extending from the fourth cell, the support locating the plurality of prismatic cells such that the third terminal of the third cell overlaps the fourth terminal of the fourth cell; and further including a second compression member removably coupled to the support, the second compression member holding the third terminal of the third cell in contact with the fourth terminal of the fourth cell, the second compression member including a second plurality of heat sink features.

17. The battery assembly of claim 16, wherein the plurality of heat transfer members of the compression member, the second plurality of heat transfer members of the second compression member, and the support cooperate to define a conduit that receives a flow of air to cool the first cell, the second cell, the third cell, and the further cell.

18. The battery system of claim 1, wherein the plurality of prismatic battery cells further includes a third cell having a third terminal extending from the third cell and a fourth cell having a fourth terminal extending from the fourth cell, the support locating the plurality of prismatic cells such that the third terminal of the third cell overlaps the fourth terminal of the fourth cell; and further including a second compression member removably coupled to the support, the second compression member holding the third terminal of the third cell in contact with the fourth terminal of the fourth cell, the second compression member including a second plurality of heat sink features.

19. The battery assembly of claim 18, wherein the plurality of heat transfer members of the compression member, the second plurality of heat transfer members of the second compression member, and the support cooperate to define a conduit that receives a flow of air to cool the first cell, the second cell, the third cell, and the further cell.

20. A method of assembling a battery assembly, comprising the steps of:
holding a plurality of prismatic battery cells with a support, the support having a negative terminal and a positive terminal, the plurality of prismatic battery cells including a first cell having a first terminal extending from the first cell and a second cell having a second terminal extending from the second cell;
electrically coupling the plurality of prismatic cells to the negative terminal of the support and the positive terminal of the support;
electrically coupling the first terminal of the first cell to the second terminal of the second cell by overlapping the first terminal of the first cell and the second terminal of the second cell;
holding the first terminal of the first cell and the second terminal of the second cell in contact with a compression member removably coupled to the support, the compression member including a plurality of heat sink features that define a conduit; and
passing air through the conduit to cool the first cell and the second cell.
